(19) United States
(12) Patent Application Publication
(10) Pub. No.: US 2012/0072271 A1
(43) Pub. Date: Mar. 22, 2012

(54) SYSTEM, METHOD, APPARATUS, AND COMPUTER PROGRAM PRODUCT FOR AN ELECTRONIC, CROWDSOURCED MARKETING CAMPAIGN

(75) Inventors: Robert L. Dessert, Canton, GA (US); LeAnna Marie Dessert, Canton, GA (US)

(73) Assignee: FIRETHORN HOLDINGS, LLC, Atlanta, GA (US)

(21) Appl. No.: 12/945,601

(22) Filed: Nov. 12, 2010

Related U.S. Application Data
(60) Provisional application No. 61/384,539, filed on Sep. 20, 2010.

(51) Int. Cl. G06Q 30/00

(52) U.S. Cl. 705/14.1

(57) ABSTRACT

A method, system, apparatus, and computer program product are disclosed for receiving a discount at a wireless device. The discount may be redeemable at a merchant. The discount may be part of a marketing campaign which defines a number of discounts receivable and potentially redeemable by the wireless device. A first discount may be redeemable by a first wireless device which initiated the marketing campaign. A second discount may be redeemable by at least one second wireless device, which is different than the first wireless device.

### CROSS REFERENCE TO RELATED APPLICATIONS

This application claims priority to and incorporates by reference U.S. provisional patent application entitled “SYSTEM, METHOD, APPARATUS, AND COMPUTER PROGRAM PRODUCT FOR AN ELECTRONIC, CROWDSOURCED MARKETING CAMPAIGN” filed on Sep. 20, 2010 and having Ser. No. 61/384,539.

### DESCRIPTION OF THE RELATED ART

The world is undergoing massive change as users of electronic devices are more connected to services and other users. Ubiquitous connectivity has provided opportunities for massive collaboration on ideas around the globe. This collaboration is sometimes referred to as “crowdsourcing.” Instead of relying on expensive consultants, many companies have turned to open calls to the public for collaboration.

There are many benefits to crowdsourcing. For example, reward is generally based on results, thus companies can explore many ideas inexpensively and only pay once a good idea is discovered. Some argue that web-based crowdsourcing is beneficial because creativity is greater when people can suggest ideas anonymously (e.g., using a pseudonym). Others suggest that the social nature of crowdsourcing is beneficial to our instinctual human needs of companionship, kinship, belonging, and community. In addition, businesses may have limited, internally-available talent, and crowdsourcing provides better opportunities to reach a wider, stronger base of talent.

An opportunity exists to bring about positive social and economic change using wireless devices, wireless networks, and the Internet. The following figures, detailed description, and claims describe one or more solutions to realize this opportunity.

### BRIEF DESCRIPTION OF THE DRAWINGS

In the figures, like reference numerals refer to like parts throughout the various views unless otherwise indicated.

FIG. 1 depicts a marketing campaign system;

FIG. 2A depicts a wireless device;

FIG. 2B depicts a computer;

FIG. 3A depicts a swarm user client;

FIG. 3B depicts a client campaign record;

FIG. 3C depicts a client discount record;

FIG. 4A depicts a swarm server;

FIG. 4B depicts a user record;

FIG. 4C depicts a server campaign record;

FIG. 4D depicts a merchant record;

FIG. 5 depicts a method for interacting with a swarm server;

FIG. 6 depicts a process for creating a new swarm user client account;

FIG. 7 depicts a process for adding friends to a marketing campaign;

FIG. 8 depicts a state diagram for various user states;

FIG. 9A through FIG. 9F depict a series of screenshots on a wireless device;

FIG. 10 depicts a marketing campaign; and

FIG. 11 depicts a marketing campaign.

### DETAILED DESCRIPTION

This detailed description is divided into various subsections to help assist the reader in understanding the solutions proposed herein. The division between subsections does not import any limitation or substantive division among the subsections i.e. the detailed description should be viewed as a whole. The subsections are as follows: (1) terms of art, (2) existing problems and proposed solutions, (3) components of the proposed solutions, and (4) operation of the proposed solutions. To the extent possible, the components of the solutions will be described and defined earlier in the detailed description, and the operation of the components as part of the solutions will be described later in the detailed description.

### Terms of Art

In this description, the word “exemplary” is used herein to mean “serving as an example, an instance, or an illustration.” Any embodiment described herein as “exemplary” is not necessarily to be construed as preferred or advantageous over other embodiments.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed or processed.

In this description, the terms “component,” “module,” “system,” “record” and the like are intended to refer to a computer-related entity, which may be hardware, software, software in execution, or any combination thereof. For example, a component may be, but is not limited to be, a processor, a process running on a processor, an object, an executable, a thread of execution, a program, a computer, a wireless device, or any combination thereof. By way of illustration, both an application running on a computing device and the computing device may be a component. One or more components may reside within a process and/or thread of execution. One or more components may be localized on one computer and/or distributed among two or more computers. In addition, these components may execute from various computer-readable media having various data structures stored thereon. The components may communicate by way of local and/or remote processes.

In this description, the terms “electronic device,” “communication device,” “wireless device,” “wireless telephone,” “wireless communications device,” and “wireless handset,” and “computing device” are used interchangeably. A wireless device may be a cellular telephone, a pager, a personal digital assistant (“PDA”), a smartphone, a navigation device, or a computer with a wireless connection.

### Existing Problems and Proposed Solutions

One problem that exists in the marketplace is consumers perceive marketing opportunities for businesses but are unable to communicate, share, or be rewarded for presenting marketing opportunities to businesses. Often, these business are small businesses and focused on the execution of day-to-day operations, which prohibits exploration of new marketing opportunities. For instance, Mark is a local banquet waiter who drinks coffee at the same coffee shop every morning. The coffee shop is called Coffee Co. Mark is very observant and notices that the competing coffee shop across the street, Java, Inc., has few customers every Tuesday because his favorite Coffee Co. shop offers a discount of 10% off lattes on Tuesday. While Mark is a loyal Coffee Co. coffee consumer, he would not mind drinking Java, Inc's coffee if there were a better discount on Tuesday. To bring about such a change, Mark would have to write a letter or email to the marketing department at Java, Inc. explaining how they could get more business in his neighborhood by providing a discount of 15% (5% more than Coffee Co.). But, such effort would not be worth his time and effort because he would only save an additional 5% percent on a latte (a relatively low cost consumer good).

A consumer like Mark is perhaps one of the best sources of information about marketing opportunities because he (1) uses the product daily, (2) knows the local neighborhood, (3) is observant, and (4) sees the relationship between the discount provided by Coffee Co. and the missed opportunity by Java, Inc. However, none of Mark's observations, suggestions, or ideas will ever reach Java, Inc. because there exists no efficient means to communicate, share, and be rewarded for identifying and solving market problems similar to the one described above.

Note that in the foregoing example, the companies are large corporations which likely operate on a region-by-region basis and have sophisticated marketing departments. As discussed, a large, successful corporation like Java, Inc. could benefit from having an avenue to receive information from a consumer like Mark. In addition, smaller businesses could also benefit from being able to interact with consumers. Note that smaller businesses do not have the same resources as highly-successful corporations like Coffee Co. or Java, Inc.

Take a coffee cart operator for example. A coffee cart is a one-person operation that sells coffee to customers on a sidewalk. Assume that Mindy operates a local coffee cart called Caffeine Cart. Mindy is the owner and operator of her sole proprietorship. She must oversee and execute every aspect of the business. Assume that Caffeine Cart is part of the same market described in the foregoing example with Coffee Co. and Java, Inc. Mindy too may not have the ability or resources to notice that sales of lattes are down on Tuesday because she is too busy scrambling every morning to buy coffee, grind coffee, obtain permits, pay for electricity, chat with frequent customers, etc. Therefore, a small business could be benefited by receiving the marketing solution proposed by Mark (providing a discount of 15% on Tuesdays, 5% higher than Coffee Co.).

As stated, consumers may not be rewarded for identifying marketing problems. If Mark were to walk over to Caffeine Cart and describe the situation to Mindy, she may accept his advice. She may even give him a free cup of coffee as a reward. However, if Mark were to walk into Java, Inc. with the same advice, the baristas would not be able to do anything to change the corporation's marketing direction because the baristas likely lack the authority to create, accept, or implement Mark's marketing solution. Thus, consumers may have limited incentives to share good ideas.

Another problem that exists in the marketplace is consumers cannot anonymously present marketing ideas to companies. As stated in the foregoing example, Mark drinks coffee at Coffee Co. every morning. If he were to walk over to Java, Inc., drop an anonymous suggestion in the “suggestion box,” then he will not be rewarded for identifying the problem. Likewise, if Mark told Mindy at the Caffeine Cart that she was missing a marketing opportunity, she may turn him away because she has identified him as going into the Coffee Co. every morning and thus considers him a friend of the competition.

Thus, in sum, there are a number of problems with consumers identifying marketing opportunities. First, there is far too much effort required for too little gain (particularly for low cost items like lattes). Second, there is no unique reward for identifying marketing opportunities (e.g., a free latte for suggesting a great marketing campaign). Third, there is no anonymous means to present a marketing campaign and still receive a reward for your efforts (assuming the efforts were worth rewarding). Therefore, in sum, the marketplace is faced with a number of problems that could be addressed by allowing consumers to efficiently initiate and participate in marketing campaigns.

What is needed is an electronic marketing campaign system, method, apparatus, and computer program product that allows users to initiate and be rewarded for presenting marketing campaigns. In one embodiment, the marketing campaign may be operable to have a consumer initiate a marketing campaign to a merchant via a wireless device. The marketing campaign may have one or more discounts defined for each of the various consumers who participate. The merchant may be able to view, modify, and accept the marketing campaign at a server. The consumer who initiated the marketing campaign may receive the discount via the wireless device. In one embodiment, the consumer may store the discount within the wireless device for redemption at a later time. In another embodiment, the consumer may share the discount with other friends via a social networking service. The friends may receive a different discount based on the time they received the discount, the number of other consumers who already accepted the discount, or other conditions defined by the marketing campaign or the merchant. The discounts may be redeemable via the wireless device at a point-of-sale operated by the merchant. A successful marketing campaign may result in a “swarm” of customers visiting the merchant.

### Components of the Proposed Solutions

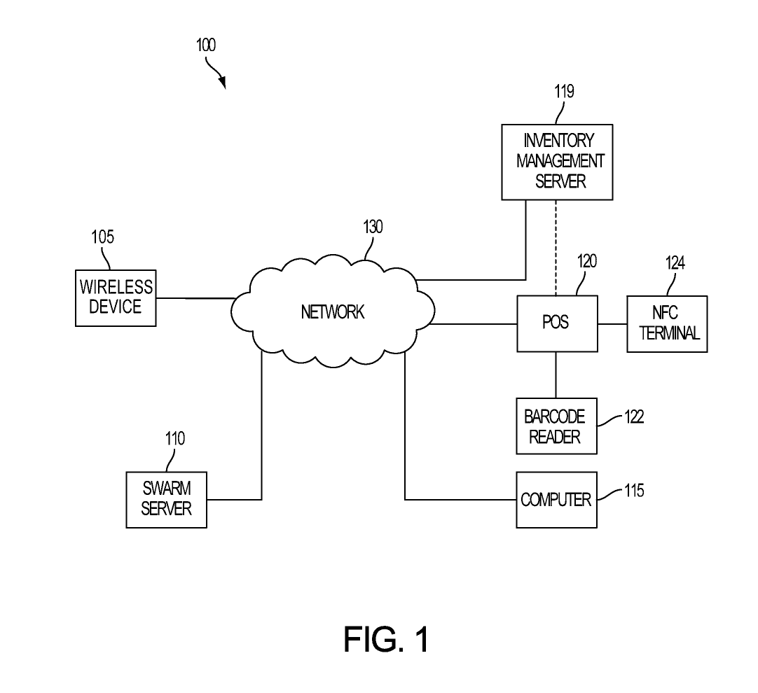

The various components of the proposed solutions will be described in further detail. Turning to FIG. 1, a marketing campaign system 100 is depicted. A wireless device 105 may be connected to a network 130. In one embodiment, the wireless device 105 may be connected to the network 130 using any one of code division multiplexed access (“CDMA”), time division multiplexed access (“TDMA”), frequency division multiplexed access (“FDMA”), orthogonal frequency division multiplexed access (“OFDMA”), global system for mobile communications (“GSM”), Analog Advanced Mobile Phone System (“AMPS”), Universal Mobile Telecommunications System (“UMTS”), 802.11a/b/n (“WiFi”), World Interoperability for Microwave Access (“WiMAX”), Bluetooth, near-field communication (“NFC”) or other wireless communication technology. In yet another embodiment, the wireless device 105 may be connected to a docking station (not shown), which may be connected to the network 130.

Many commercial versions of the wireless device 105 may be found in the marketplace today. For example, the wireless device 105 may be a Google® Nexus One™ device, an Apple® iPhone® device, an HTC® Droid Incredible™ device, a LG® Dare™ device, a Blackberry® Storm™ device, a Motorola® Droid™ device, a Samsung® Omnia™ II device, etc. One of skill in the art will appreciate that the foregoing enumeration of wireless devices is illustrative and not exhaustive.

The network 130 may be the Internet in one embodiment. The Internet is a world-wide, redundant network of computers utilizing the Internet Protocol (“IP”). In another embodiment, the network 130 may be a local area network (“LAN”) with wireless capabilities (e.g., a local WiFi hotspot). In yet another embodiment, the network 130 may be a subscription-based network operated by a wireless carrier (e.g., Verizon, Sprint, T-Mobile, AT&T, etc.).

A swarm server 110 may be connected to the network 130. The swarm server 110 may manage a marketing campaign. In one embodiment, the swarm server 110 may be a stand-alone network server capable of serving many user clients and connections. As more computing moves into the “cloud,” the swarm server 110 may be embodied as rented time-slices of memory, processing, and storage space, all of which are allocated among several computers. The Amazon® Elastic Compute Cloud is an example of cloud-based computing.

A computer 115 may be connected to the network 130. In one embodiment, the computer 115 may be a personal computer or a laptop computer. The definition of a personal computer is currently in a state of flux as more devices challenge consumers' expectations. For example, the Nexus One™ device developed by Google is a wireless device, which is very similar in processing capability to a standard personal computer. Further, more and more consumers are relying on their wireless devices to perform functionality traditionally performed on a personal computer. Thus, the computer 115 is shown as being a separate entity from the wireless device 105, but in some embodiments, the wireless device 105 and the computer 115 may be used interchangeably. Popular manufacturers of computer hardware and software include Dell, Microsoft, HP, Apple, Intel, Nvidia, Acer, Lenovo, etc.

A point-of-sale terminal 120 may be connected to the network 130. In one embodiment, the point-of-sale terminal 120 may be a collection of hardware and software that allows a merchant to register (or “ring up”) a sale of goods and/or services. One of skill in the art may refer to the point-of-sale terminal 120 as an electronic cash register, which may be a misnomer because many points-of-sale are cashless and process transactions electronically. The point-of-sale terminal 120 may be operated by a store clerk. In one embodiment, the point-of-sale terminal 120 is operated by the consumer, which is commonly referred to as “self checkout.” The point-of-sale terminal 120 may be equipped with a display (not shown) to provide feedback to the store clerk and/or the consumer. Common manufactures of point-of-sale hardware and software include Microsoft, NCR, Epson, Fujitsu-ICL, Radiant/Aloha, Micros, Citadel, IBM, etc.

The point-of-sale terminal 120 may be connected to a barcode reader 122. The barcode reader 122 may be a pen-type reader, a laser scanner, a camera-based reader, a charged coupled device (“CCD”) device, an omni-directional scanner, etc. The barcode reader 122 may be housed in a fixed housing near the point-of-sale terminal 120. In one embodiment, the barcode reader 122 may be housed in a wireless device. The barcode reader 122 may be operable to read one-dimensional barcodes (e.g., UPC-A). Exemplary one-dimensional barcodes may include, but are not limited to, U.P.C., Codabar, Code 25—Non-interleaved 2 of 5, Code 25—Interleaved 2 of 5, Code 39, Code 93, Code 128, Code 128A, Code 128B, Code 128C, Code 11, CPC Binary, DUN 14, EAN 2, EAN 5, EAN 8, EAN 13, Facing Identification Mark, GS1-128 (formerly known as UCC/EAN-128), GS1 DataBar formerly Reduced Space Symbology (“RSS”), HIBC (HIBCC Bar Code Standard), ITF-14, Latent image bar code, Pharmacode, Plessey, PLANET, POSTNET, Intelligent Mail Bar code, MSI, PostBar, RM4SCC/KIX, JAN, Telepen, etc.

In another embodiment, the barcode reader 122 may be operable to read two-dimensional barcodes (e.g., MaxiCode). The two-dimensional barcode may include, but is not limited to, the following symbologies: Aztec Code, 3-DI, ArrayTag, Small Aztec Code, Chromatic Alphabet, Chromocode, Codablock, Code 1, Code 16K, Code 49, ColorCode, Compact Matrix Code, CP Code, CyberCode, d-touch, DataGlyphs, Datamatrix, Datastrip Code, Dot Code A, EZcode, Grid Matrix Code, High Capacity Color Bar code, HueCode, INTACTA.CODE, InterCode, MaxiCode, mCode, MiniCode, Micro PDF417, MMCC, Nintendo e-Reader#Dot code, Optar, PaperDisk, PDF417, PDMark, QR Code, QuickMark Code, Semacode, SmartCode, Snowflake Code, ShotCode, SuperCode, Trillcode, UltraCode, UnisCode, VeriCode, VSCode, WaterCode, etc.

The point-of-sale terminal 120 may be connected to a near-field communication (“NFC”) terminal 124. NFC is a short-range communication technology which allows two devices to exchange data within a range of approximately 10 centimeters (approximately 3.94 inches). Currently, NFC is not supported by many commercial wireless devices. However, more and more wireless devices will be including support for NFC. Likewise, more point-of-sale terminals will have support for NFC and NFC-based transactions. Thus, it is envisioned that point-of-sale terminals and wireless devices may be able to communicate with one another to securely conduct electronic commerce wirelessly using NFC.

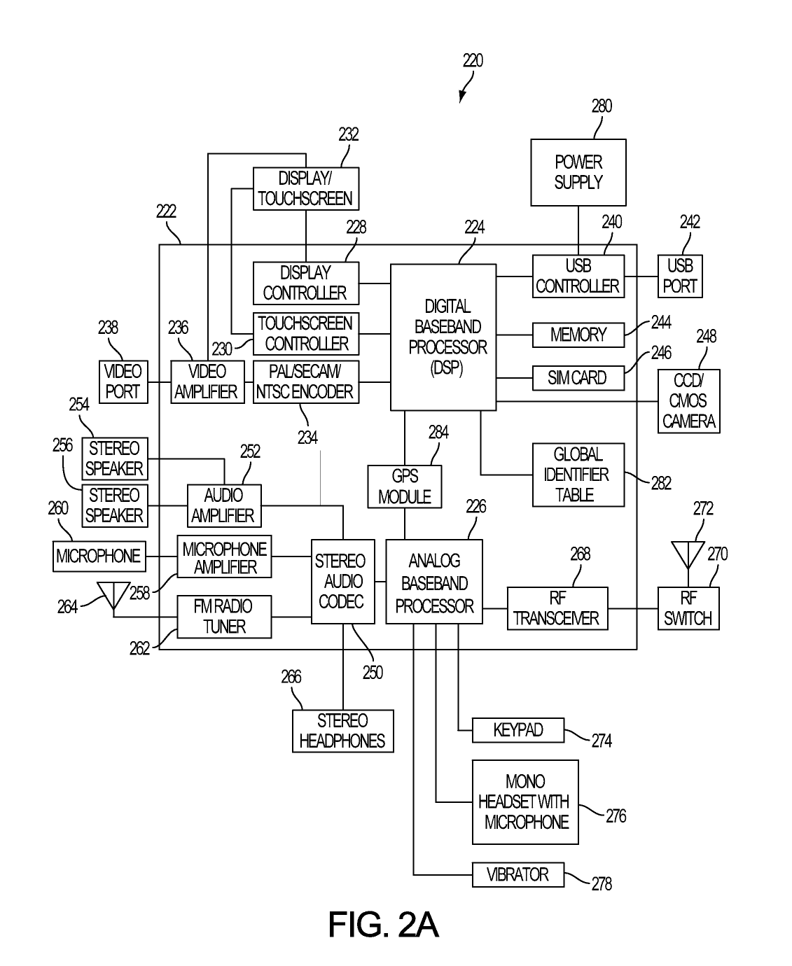

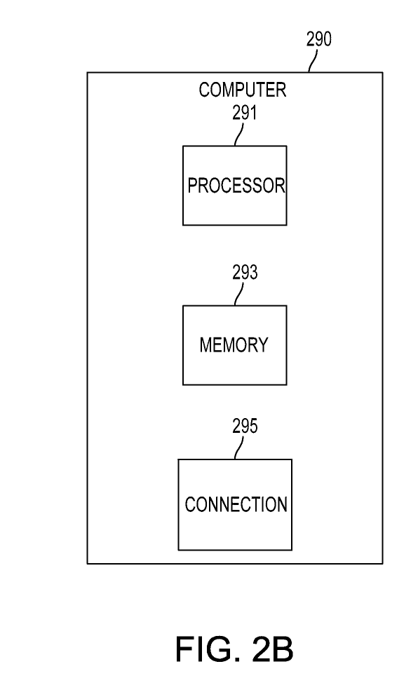

Turning to FIG. 2A, a wireless device 205 is depicted. As shown, the wireless device 205 includes an on-chip system 222 that includes a digital baseband processor 224 and an analog baseband processor 226 that may be coupled together. As illustrated in FIG. 2A, a display controller 228 and a touchscreen controller 230 may be coupled to the digital baseband processor 224. In turn, a touchscreen display 232 external to the on-chip system 222 may be coupled to the display controller 228 and the touchscreen controller 230.

FIG. 2A further depicts a video encoder 234, e.g., a phase alternating line (“PAL”) encoder, a sequential couleur a memoire (“SECAM”) encoder, or a national television system(s) committee (“NTSC”) encoder, may be coupled to the digital baseband processor 224. Further, a video amplifier 236 may be coupled to the video encoder 234 and the touchscreen display 232. Also, a video port 238 may be coupled to the video amplifier 236. As depicted in FIG. 2A, a universal serial bus (“USB”) controller 240 may be coupled to the digital baseband processor 224. Also, a USB port 242 may be coupled to the USB controller 240. A memory 244 and a subscriber identity module (“SIM”) card 246 may also be coupled to the digital baseband processor 224. Further, as shown in FIG. 2A, a digital camera 248 may be coupled to the digital baseband processor 224. In one embodiment, the digital camera 248 may be a charge-coupled device (“CCD”) camera or a complementary metal-oxide semiconductor (“CMOS”) camera.

As further depicted in FIG. 2A, a stereo audio CODEC 250 may be coupled to the analog baseband processor 226. Moreover, an audio amplifier 252 may coupled to the stereo audio CODEC 250. In one embodiment, a first stereo speaker 254 and a second stereo speaker 256 may be coupled to the audio amplifier 252. FIG. 2A depicts how a microphone amplifier 258 may be also coupled to the stereo audio CODEC 250. Additionally, a microphone 260 may be coupled to the microphone amplifier 258. In one embodiment, a frequency modulation (“FM”) radio tuner 262 may be coupled to the stereo audio CODEC 250. Also, an FM antenna 264 may be coupled to the FM radio tuner 262. Further, stereo headphones 266 may be coupled to the stereo audio CODEC 250.

FIG. 2A further depicts how a radio frequency (“RF”) transceiver 268 may be coupled to the analog baseband processor 226. An RF switch 270 may be coupled to the RF transceiver 268 and an RF antenna 272. As depicted in FIG. 2A, a keypad 274 may be coupled to the analog baseband processor 226. Also, a mono headset with a microphone 276 may be coupled to the analog baseband processor 226. Further, a vibrator device 278 may be coupled to the analog baseband processor 226. FIG. 2A also depicts that a power supply 280 may be coupled to the on-chip system 222. In one embodiment, the power supply 280 may be a direct current (“DC”) power supply that provides power to the various components of the wireless device 205. Further, in one embodiment, the power supply may be a rechargeable DC battery or a DC power supply that is derived from an alternating current (“AC”) to DC transformer that is connected to an AC power source.

In one embodiment, the wireless device 205 may include a global positioning system (“GPS”) module 284 coupled to the digital baseband processor 224 or the analog baseband processor 226. The GPS module 284 and at least one of the processors 224, 226 may be utilized to locate the wireless device 205.

As depicted in FIG. 2A, the touchscreen display 232, the video port 238, the USB port 242, the camera 248, the first stereo speaker 254, the second stereo speaker 256, the microphone 260, the FM antenna 264, the stereo headphones 266, the RF switch 270, the RF antenna 272, the keypad 274, the mono headset 276, the vibrator 278, and the power supply 280 may be external to the on-chip system 222.

Turning to FIG. 2B, a computer 290 is depicted. The computer 290 may have a processor 291, a memory 293, and a connection 295. The processor 291 may be configured by software instructions to perform a variety of methods, including the methods of the various embodiments described herein. For example, the processor 291 may comprise a general purpose processor (e.g., x86, ARM, etc.), a digital signal processor (“DSP”), an application specific integrated circuit (“ASIC”), a field programmable gate array (“FPGA”), etc.

The memory 293 may be any optical disk storage, any magnetic disk storage, or any other medium operable to store logic and/or data accessible by the computer 290. The memory 293 may comprise random access memory (“RAM”), read-only memory (“ROM”), electrically erasable programmable read-only memory (“EEPROM”), compact-disc read-only memory (“CD-ROM”), digital video disc read-only memory (“DVD ROM”), solid-state memory, etc.

The connection 295 may generally allow connectivity to other computers, wireless devices, laptops, servers, etc. The connection 295 may comprise a network interface card (“NIC”), a modem, a universal serial bus port (“USB”), a Firewire port, a 3G/4G wireless modem, a near-field communication connection (“NFC”), etc. The connection 295 may be any other wired connection, any other wireless connection, any other magnetic connection, any other visual connection, any other audible connection, etc.

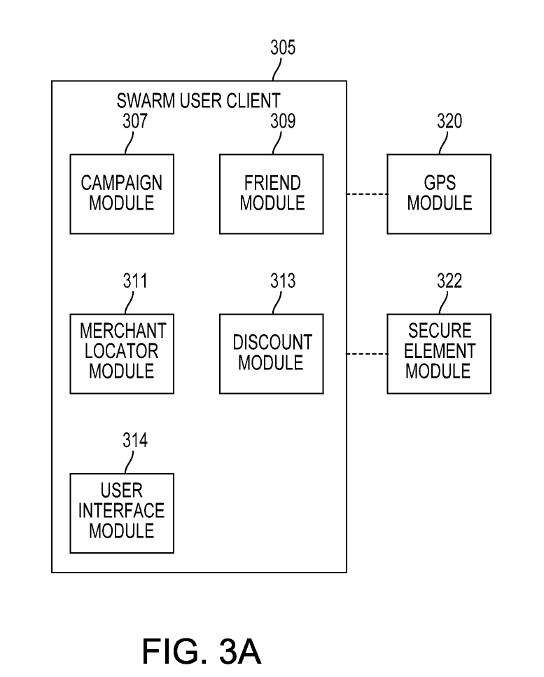

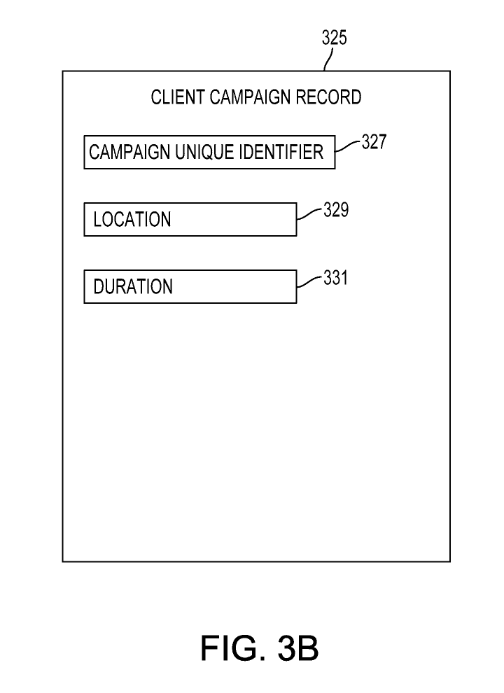

Turning to FIG. 3A, a swarm user client 305 is depicted. The swarm user client 305 may reside on a wireless device or a computer. In one embodiment, the swarm user client 305 may reside on the wireless device 105 as shown in FIG. 1 above.

The swarm user client 305 may have a number of modules. In one embodiment, the swarm user client 305 may have a campaign module 307, a friend module 309, a merchant locator module 311, a discount module 313, and a user interface module 314. Further, the swarm user client 305 may be operable to communicate with a global positioning system (“GPS”) module 320 and a secure element module 322.

The campaign module 307 may be generally operable to manage the marketing campaigns in which the swarm user client 305 is participating. For example, the campaign module 307 may manage various aspects of the marketing campaign such as: the start date, the end date, the duration, the merchant's name, the merchant's location, the number of other participants in the campaign, etc.

The friend module 309 may be generally operable to manage friends connected to the marketing campaign. For example, the friend module 309 may manage information and functionality related to sharing marketing campaigns (and associated discounts) with friends, who may or may not have the swarm user client 305 installed on their wireless device or computer. In one aspect, the friend module 309 may be operable to send an invitation to a friend to have them install the swarm user client 305, thus bringing more users into the marketing campaign.

The merchant locator module 311 may be generally operable to find the real-world locations of the merchants. In one embodiment, the merchant locator module 311 may communicate with the campaign module 307 to gather the merchant's address. The merchant locator module 311 may then ascertain the current location using the GPS module 320 and then plot a route to the merchant's location. In another embodiment, the merchant locator module 311 may connect to the Internet and find nearby merchants based on a current location of the wireless device (as determined with the GPS module 320).

The discount module 313 may be generally operable to manage discounts. In one embodiment, the discount module 313 may initiate, receive, accept, or redeem discounts. In another embodiment, the discount module 313 may store the discount in the secure element module 322 to prevent fraudulent redemption of discounts. The discount module 313 may communicate with the campaign module 307 to determine the potential discounts available for a given marketing campaign. In one embodiment, the discount module 313 may communicate with the friend module 309 to share discounts with friends. The discount module 313 may communicate with the user interface module 314 to present the discount for redemption at a merchant. Turning back to FIG. 1, a 2-D barcode may be displayed on the display of the wireless device 105 such that the point-of-sale terminal 120 may scan the wireless device's 105 display and determine the discount. Further, the discount module 313 may communicate with the NFC terminal 124 to communicate the discount.

The user interface module 314 may generally manage the user interface of the swarm user client 305. The user interface module 314 may accept input from humans and/or computers. Likewise, the user interface module 314 may present information readable by humans and/or computers. In one embodiment, the user interface module 314 may visually present the discounts to merchants such that the discounts may be redeemed. In another embodiment, the user interface module 314 may present a user interface comprised of menus, graphics, sounds, charts, graphs, maps, tables, icons, etc.

Turning to FIG. 3B, a client campaign record 325 is depicted. The client campaign record 325 is an exemplary data structure operable to manage a marketing campaign. In one embodiment, the client campaign record 325 may be held within the campaign module 307.

The client campaign record 325 may have a campaign unique identifier 327. The campaign unique identifier 327 may be a unique numeric, alphanumeric, algorithmic, or symbolic mechanism to uniquely identify and retrieve the client campaign record 325.

A location 329 may relate to the physical location of an ongoing campaign. The location 329 may simply be a street address. Alternatively, the location may be an online location (e.g., amazon.com). In one embodiment, the location 329 may be a point in space (e.g., a latitude/longitude coordinate). In another embodiment, the location 329 may be a polygon which represents a bounded region. The bounded region of the polygon may be a subregion of a city that is targeted for a marketing campaign.

A duration 331 may relate to the temporal duration of the marketing campaign. The duration may be an exemplary condition against which the marketing campaign may calculate the discount's validity, value, amount, etc. The duration 331 may be measured in seconds, minutes, hours, days, weeks, months, years, etc. In one embodiment, the duration 331 may or may not be continuous. In one embodiment, the duration 331 may have black-out days for which the campaign is inactive. For example, the Fireworks Co. may run a promotion to sell firecrackers at 5% off in the month of July, but the discount would not be valid on July 4, the Independence Day of the United States, because fireworks sales are seasonally high on that day (due to fireworks celebrations). Thus, such a black-out day may be reflected in the duration 331.

Turning to FIG. 3C, a client discount record 340 is depicted. The client discount record 340 is an exemplary data structure operable to manage a discount 343. In one embodiment, the client discount record 340 may be held within or associated with the discount module 313.

A discount unique identifier 341 may be associated with the client discount record 340. The discount unique identifier 341 may be a unique numeric, alphanumeric, algorithmic, or symbolic mechanism to uniquely identify and retrieve the client discount record 340.

A discount 343 may be associated with the client discount record 340. The discount 343 may be any type of conceivable marketing discount. In one embodiment, discounts 343 may be implemented as formulas written in software to affect the monetary relationships of the parties. In another embodiment, the percentage discount may be associated with a particular item (e.g., “20% off one bar of soap”). In yet another embodiment, the percentage discount may be associated with a subtotal or total cost of a transaction (e.g., “20% off the total transaction”). In yet another embodiment, the discount 343 may be a rebate which is payable at a later time. In still another embodiment, the discount 343 may be the right to receive a second item at a reduced price. For example, the discount 343 may be “buy one bar of soap, receive the second bar at 50% off” Likewise, the discount 343 may be “buy one bar of soap, receive the second bar free.”

One of skill in the art will appreciate that the discount 343 may be any conceivable marketing promotion, deal, rebate, coupon, trade-in, barter, swap, etc. Further, it is beyond the scope of this document to describe the infinite types of discounts. As one skill in the art will quickly recognize, one goal of this solution is to enable users to create user-defined discounts that users desire.

A barcode image 345 may be associated with the client discount record 340. Turning back to FIG. 1, the barcode image 345 may be presented on the display of the wireless device 105 and be operable to being scanned by the point-of-sale terminal 120. The barcode image 345 may be generated dynamically seconds before the transaction is completed. In one embodiment, the barcode image 345 may be stored in the wireless device or at a server. If the barcode image 345 is stored at the wireless device, the barcode image 345 may be stored in the secure element module 322 to reduce the risk of fraud, tampering, hacking, etc. As described above in FIG. 1, the barcode reader 122 may be operable to reading many types of barcodes, and, as such, the barcode image 345 associated with the client discount record 340 may any of the barcodes described.

An acceptance time 347 may be associated with the client discount record 340. The acceptance time 347 may be the real-world time when the discount 343 was accepted at the swarm user client 305. The acceptance time 347 may be valuable to merchants wishing to track the acceptance of discounts propagated throughout the marketing campaign. For example, knowing that males age 18-25 tend to accept discounts within seconds, no matter the amount of the discount 343, may be ascertained by iterating through the client discount records 340 and analyzing the acceptance times 347.

One of skill in the art will appreciate that the client campaign records 325 and the client discount records 340 may be interrelated in any conceivable manner. For example, one client campaign record 325 may have multiple client discount records 340 associated with it when, for example, the swarm user client 305 has accepted multiple discounts 343 related to the same marketing campaign.

A redemption time 348 may be generally operable to track the time at which the discount 343 has been redeemed at a merchant. In one embodiment, the redemption time 348 is a date and time. The redemption time 348 may be used to perform analysis on the redemption behaviors of the users.

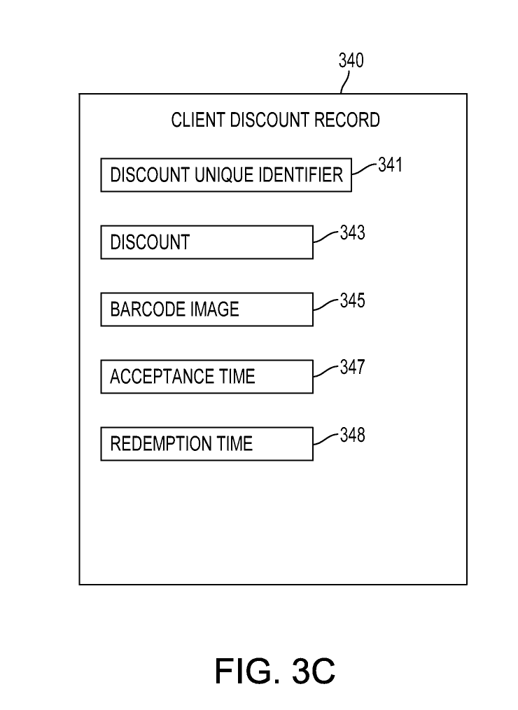

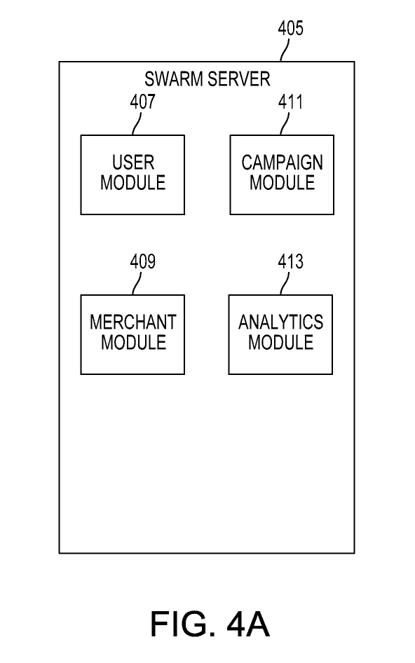

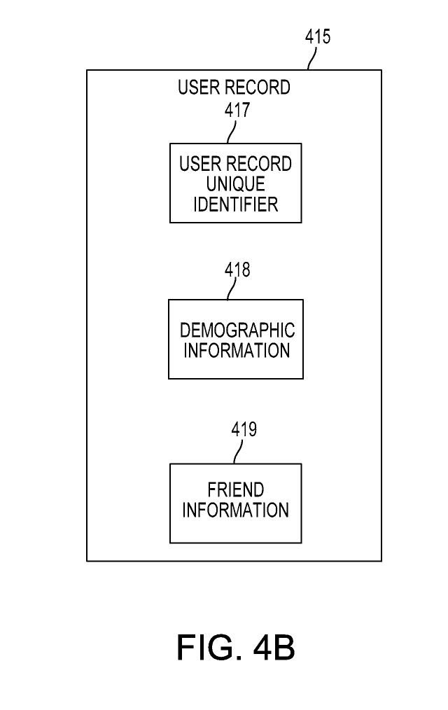

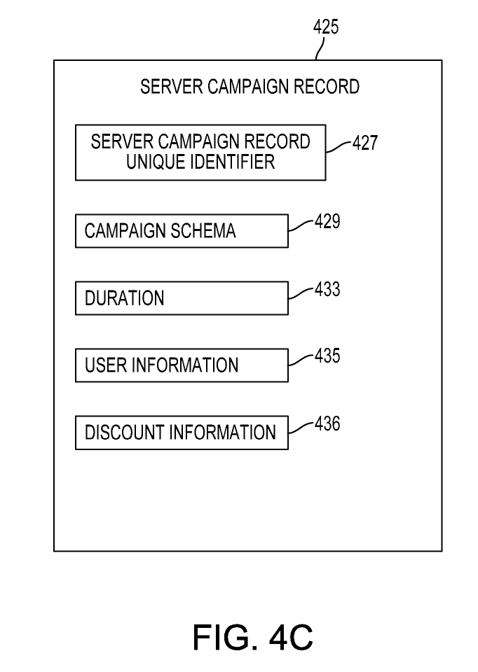

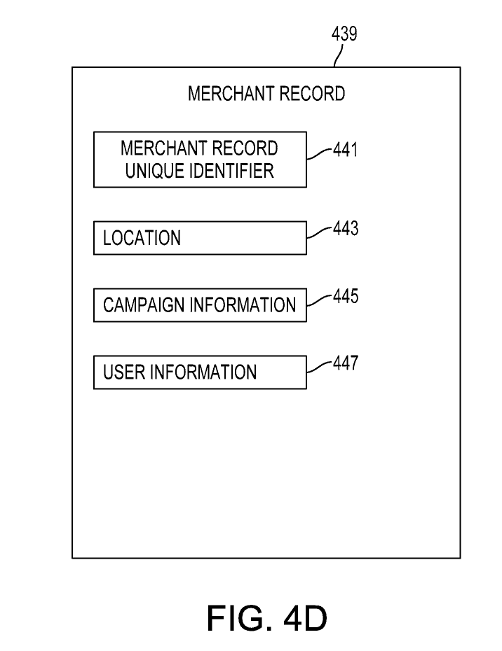

Turning to FIG. 4A, a swarm server 405 is depicted. The swarm server 405 may be generally operable to manage users, marketing campaigns, discounts, merchants, and analytics. Referring back to FIG. 1, the swarm server 110 may be configured similarly to the swarm server 405.

A user module 407 may generally manage the users participating in a marketing campaign. The user module 407 may manage which users are currently registered with the swarm server 405. In one embodiment, the user module 407 may collect basic identification information from users (e.g., name, age, address, income, interests, etc.). In one embodiment, the user module 407 may store the gathered information in an encrypted format to protect against user identity theft. In one embodiment, the user module 407 may be externally accessible by users such that they may modify their information via a web-based interface. A web-based interface as described herein could be based on any of the following technologies: HyperText Markup Language (“HTML”), Extensible HyperText Markup Language (“XHTML”), Really Simple Syndication (“RSS”), Extensible Markup Language (“XML”), Wireless Markup Language (“WML”), Javascript, Ruby on Rails, PHP, Adobe® Flash, Asynchronous JavaScript and XML-based (“Ajax”), Scalable Vector Graphics (“SVG”), etc.

In another embodiment, the user module 407 may be coupled to an existing database of user information held by a social networking service (e.g., Google® Buzz™ service, Facebook® service, Twitter® service, etc.). Thus, the user module 407 may merely be an association with another database of users which exists externally to the swarm server 405.

A campaign module 411 may generally manage data related to the various marketing campaigns. The campaign module 411 may manage which users are participating in a marketing campaign. Likewise, the campaign module 411 may manage which users have received a particular discount associated with a marketing campaign. Further, the campaign module 411 may manage which discounts have been shared with friends of users.

A merchant module 409 may generally manage the data related to real-world merchants. The merchant module 409 may be connected to and communicate with the user module 407, the campaign module 411, and the analytics module 413.

In one embodiment, the merchant module 409 may provide a web-based interface for merchants to register and login to their account. In one embodiment, the web-based interface may allow the merchants to initiate a campaign via the campaign module 411. In another embodiment, the web-based interface may allow the merchants to view participating users via the user module 407. In yet another embodiment, the web-based interface may present information as generated and analyzed by the analytics module 413.

An analytics module 413 may generally manage analysis of data generated and stored by the user module 407, the campaign module 411, and the merchant module 409. In one embodiment, the analytics module 413 may be connected to an external module or external server, either of which may provide additional data for analysis. For example, the analytics module 413 may connect to Facebook to provide another source of data for analytics.

In one embodiment, the analytics module 413 may present analytics information via a web-based interface accessible by the merchants via the merchant module 409. The analytics module 413 may present the information in the form of graphs, charts, tables, lists, etc. such that merchants may quickly and efficiently see how a particular marketing campaign or particular discount is performing.

Turning to FIG. 4B, a user record 415 is depicted. The user record 415 may be an exemplary data structure operable to manage users. A user record unique identifier 417 may be associated with the user record 415. In one embodiment, the user record unique identifier 417 may be a unique numeric, alphanumeric, algorithmic, or symbolic mechanism to uniquely identify and retrieve the user record 415.

Demographic information 418 may be associated with the user record 415. In one embodiment, the demographic information may contain the following information about the user: name, age, address, government-issued identifier (e.g., social security number), telephone number, income, education, employment history, social network identities, etc. The demographic information 418 may be employed by the analytics module 413 to generate analytics about users participating in marketing campaigns.

In one embodiment, the demographic information 418 is user-defined and may be modified by the user. For example, the user may input their name and age via the swarm user client 305, as described in FIG. 3A above. Similarly, the users may manage their demographic information 418 via a web-based interface at the swarm server 405. In another embodiment, the demographic information 418 may be derived from a third-party source. For example, the demographic information may be retrieved from publicly available information in governmental databases. In addition, demographic information 418 may be supplied by a social networking service like MySpace. One of skill in the art will note that the information held at a third-party source may be user-defined in some situations (e.g., Facebook) and not in others (e.g., a government database).

In one embodiment, user records 415 may be associated with other user records to manage a friend relationship between two users. For example, if Mark and Doug were friends on Facebook, then the user record 415 may contain additional information in the friend information 419. Specifically, Mark's user record 415 may indicate that Doug is a friend by referencing Doug's user record unique identifier 417 in the friend information 419. Likewise, Doug's friend information 419 may contain Mark's user record unique identifier 417. One of skill in the art will appreciate that there are a number of methods for tracking the relationship of records and the foregoing example is illustrative and not exhaustive.

Turning to FIG. 4C, a server campaign record 425 is depicted. The server campaign record 425 may be operable to manage a marketing campaign at the swarm server 405. The campaign module 411 may manage the collection of server campaign records 425 as each relate to a marketing campaign. A server campaign record unique identifier 427 may be associated with the server campaign record 425. The server campaign record 425 may have a campaign unique identifier 427. The server campaign unique identifier 427 may be a unique numeric, alphanumeric, algorithmic, or symbolic mechanism to uniquely identify and retrieve the server campaign unique identifier 427.

A campaign schema 429 may be associated with the server campaign record 425. In one embodiment, the campaign schema 429 may be a set of rules which define the parameters of the campaign. For example, the campaign schema 429 may be created around a marketing campaign for the Soap Company. The campaign schema 429 may contain rules that state: (1) the first person to initiate a marketing campaign will receive one free bar of soap, (2) the second through fiftieth person to purchase any item will receive 10% off their total purchase price, and (3) the fifty-first through one hundredth person to purchase any item will receive 5% off their total purchase price. In one embodiment, the campaign schema's 429 rules may be implemented in a programming language such as C, C++, Java, Perl, Ruby, Lua, Objective C, etc. In another embodiment, the campaign schema 429 may be implemented using a database technology such as MySQL, SQLite, etc. One of skill in the art may combine a programming language and a database technology to implement the campaign schema 429. In one embodiment, the campaign schema 429 may be modifiable by a user-friendly web-interface presented by the swarm server 405.

One of skill in the art will appreciate that the campaign schema 429 is a data structure that manages a plurality of discounts. Further, one of skill in the art may have an alternative approach to managing the plurality of discounts associated with a marketing campaign that differs from some of the embodiments disclosed herein. Such alternative approaches are numerous and beyond the scope of this document but would achieve the same or similar functionality as described and claimed herein.

The duration 433 of the marketing campaign may be associated with the server campaign record 425. The duration 433 may define when a marketing campaign is active or inactive. The duration 433 may be measured in seconds, minutes, hours, days, weeks, months, years, etc. The duration 433 may be continuous or non-continuation i.e. may contain temporal gaps. For example, the Soap Company may run a promotion through the holiday season. The duration 433 may be defined as being active during: (1) the first three weeks of December, (2) the day after Christmas, and (3) New Years' Day through January 8. Thus, the duration 433 may be defined such that some days of interest to the merchant are targeted (e.g., the day after Christmas) while others are not (e.g., the days leading up to Christmas).

The server campaign record 425 may contain user information 435. In one embodiment, the user information 435 may be a collection of users currently participating in the marketing campaign. In another embodiment, the user information 435 may contain users which are potentially interested in the marketing campaign. The user record unique identifier 417 associated with the user record 415 may be utilized by the user information 435 to uniquely identify and track the user records associated with the server campaign record 425.

The server campaign record 425 may contain discount information 436 which is generally operable to manage discounts. In one embodiment, the discount information 436 may determine which client discount records 340 exist in the system. Thus, the discount information 436 may act as a lookup table to determine many aspects of the discounts in the system. For example, the discount information 436 may be utilized to determine that Mark has the following discounts for a movie theater in his wireless device: (1) “buy one ticket, get the next one at half price,” (2) “purchase any small soda, receive free popcorn,” and (3) “20% off any candy item.”

Turning to FIG. 4D, a merchant record 439 is depicted. The merchant record 439 may be an exemplary data structure operable to manage a merchant relationship. The merchant record 439 may have a merchant record unique identifier 441. The merchant record unique identifier 441 may be a unique numeric, alphanumeric, algorithmic, or symbolic mechanism to uniquely identify and retrieve the merchant record 439.

A location 443 may be associated with the merchant record 439. The location 443 may relate to the physical location of a merchant. The location 329 may simply be a street address. In one embodiment, the location 329 may be a point in space (e.g., a latitude/longitude coordinate). In another embodiment, the location 329 may be a polygon which represents a bounded region. The bounded region of the polygon may be a subregion of a city that is associated with a merchant.

Campaign information 445 may be associated with the merchant record 439. In one embodiment, the campaign information 445 is a relationship to a plurality of server campaign records 425 as depicted in FIG. 4C above.

User information 447 may be associated with the merchant record 439. In one embodiment, the user information 447 is a relationship to a plurality of user records 415 as depicted in FIG. 4B above. In one embodiment, the user information 447 may additionally be associated with an external database related to customer loyalty programs (e.g., Delta® SkyMiles, Ralph's® Rewards, etc.).

### Operation of the Proposed Solutions

The operation and interaction of the components described herein will be further described in the following figures and descriptions. Reference will be made to the components described in FIG. 1 through FIG. 4D.

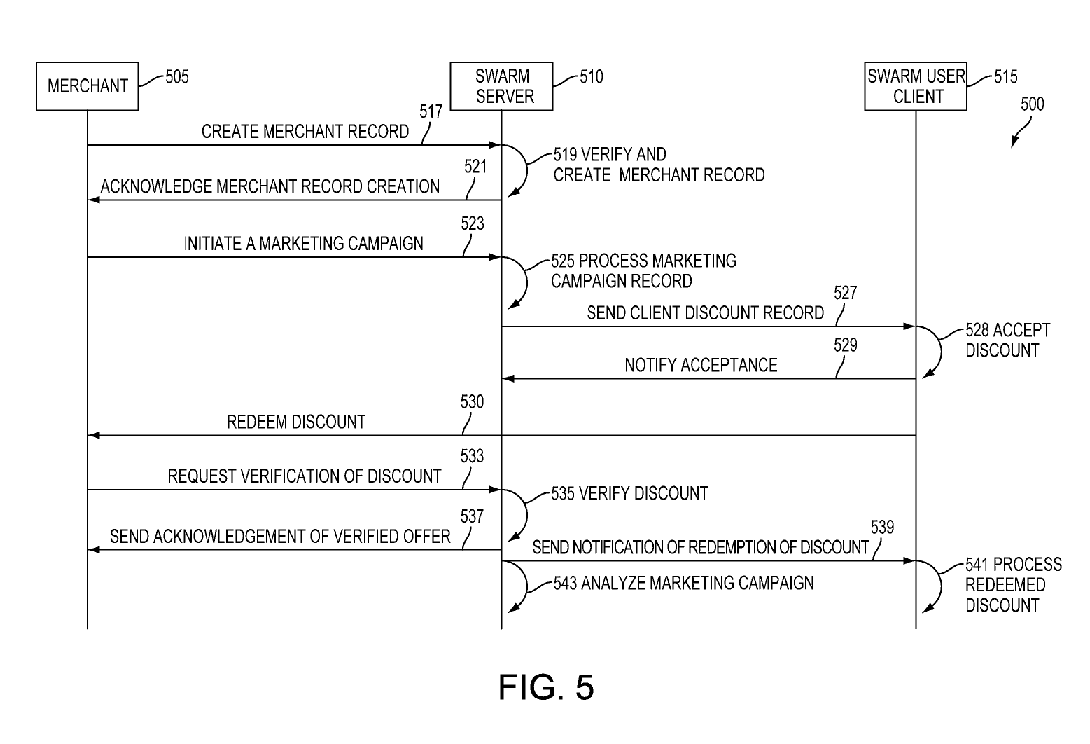

Turning to FIG. 5, a method 500 for interacting with a swarm server 510 is depicted. As shown, a merchant 505, the swarm server 510 and a swarm user client 515 may interact with one another. The merchant 505 may be a human manager of a store (e.g., the Caffeine Cart described above). In one embodiment, the swarm server 510 may be the swarm server 110 depicted in FIG. 1 above. In another embodiment, the swarm server 510 may be the swarm server 405 depicted in FIG. 4A above. In one embodiment, the swarm user client 515 may be swarm user client 305 depicted in FIG. 3A above.

At transition 517 the merchant 505 may create an account at the swarm server 510. In one embodiment, as described in FIG. 4A above, the merchant 505 may utilize the merchant module 409 to create an account. For example, the swarm server 510 may present a web-based interface which is operable to being utilized by a web-browser. Examples of web-browsers include Microsoft® Internet Explorer, Mozilla® Firefox, Google® Chrome, Apple® Safari, etc. Further, the merchant 505 may enter information related to the merchant 505 within the web-based interface. In one embodiment, the swarm server 510 may create a merchant record 439 as described in FIG. 4D above. Further, the merchant 505 may enter a location 443.

At transition 519, the swarm server 510 may verify and create a merchant record 439. In one embodiment, the swarm server 510 may verify the merchant's 505 physical location as being accurate. For example, the swarm server 510 may verify the location, as entered by the merchant 505, against a public database. An example of a public database could be a public telephone directory, a customer recommendation database (e.g., Yelp, Kudzu, etc.), a taxpayer database, a business license database, etc. Additional information gathered by the swarm server 510 may be similarly verified. Once any verification has been completed, the swarm server 510 may create the merchant record 439 using the merchant module 409 as described above in FIG. 4A and FIG. 4D.

At transition 521, the swarm server 510 may acknowledge the merchant record creation to the merchant 505. In one embodiment, the acknowledgement may simply be a pop-up window within the web-based interface stating, “merchant account successfully created.” In another embodiment, the acknowledgement may be accomplished via paper mailing to a physical address belonging to the merchant 505. Paper mailing may reduce instances of fraudulent merchant account creation. In yet another embodiment, an acknowledgement may be sent by telephone call to the publicly listed telephone number of the merchant 505. For example, the telephone call may indicate that a merchant record 439 was created and provide information to notify the swarm server 510 if there was fraudulent record creation.

At transition 523, the merchant 505 may initiate a marketing campaign. In one embodiment, the campaign module 411 may be utilized to initiate the marketing campaign. Further, the campaign module 411 may be invoked via a web-based interface to create a server campaign record 425. In one embodiment, the merchant 505 may utilize the web-based interface to define the campaign schema 429 of the marketing campaign. For example, the merchant 505 may define the campaign schema 429 as follows: (1) the first person to accept shall receive a $20.00 gift card with any purchase, (2) the second through twentieth person to accept shall receive a $10.00 gift card with any purchase, and (3) the twenty-first through fiftieth person shall receive a $5.00 gift card with any purchase.

The campaign schema 429 may contain any number of conditions. Some examples of conditions are: (1) who may initiate, receive, accept, or redeem a discount, (2) when may a user initiate, receive, accept, or redeem a discount, (3) where may the discount be initiated, received, accepted, or redeemed, (4) what is the discount being initiated, received, accepted, redeemed, etc. In one embodiment, the merchant 505 may identify demographic groups which may be interested in the marketing campaign via the campaign schema 429. For example, the merchant 505 may indicate that the marketing campaign may only be accepted by young adults, ages eighteen through twenty-two. In another embodiment, the merchant 505 may limit the marketing campaign to a particular geographical region. For example, the marketing campaign may only be accepted by individuals within Georgia and Florida. In yet another embodiment, the campaign schema 429 may limit when the discount may be received. For example, the discount is only operable to being accepted the day after a major holiday, when shopping is unusually high and buyers are selective about which stores they will visit.

In one embodiment, the duration 433 of the marketing campaign may be indicated by the merchant 505. For example, the merchant 505 may define the marketing campaign as beginning on January 1 and running through January 10. As noted above in FIG. 4C, the duration 433 may be non-linear i.e. the duration 433 may contain blackout periods or gaps of time. One of skill in the art may opt to include the duration 433 as part of the campaign schema 429.

In one embodiment, the campaign schema 429 may identify the swarm user client 515 to receive the discount and participate in the marketing campaign. For example, the campaign schema 429 may have Mark identified as being the first recipient of the client discount record 340 because he has many friends on Facebook. Thus, the merchant 505 or the swarm server 510 (via the analytics module 413) may identify Mark as being an ideal first recipient of the discount 343.

At transition 525, the swarm server 510 may process the server campaign record 425. In one embodiment, the swarm server 510 may verify that existing, identical server campaign records 425 do not exist. In another embodiment, the swarm server 510 may utilize the analytics module 413 to propose modifications to the marketing campaign based on historically analyzed data. For example, the analytics module 413 may suggest not offering discounts on the day after Thanksgiving (a major shopping day in the United States) because sales are typical high during that day irrespective of the discounts offered.

At transition 527, the swarm server 510 may send the client discount record 340 to the swarm user client 515. As described above, the campaign schema 429 may have particular swarm user clients 515 identified as being the first recipients of the discount. For example, if Mark is identified as being among the first recipients within the marketing campaign, the swarm server 510 may transmit the client discount record 340 to the swarm user client 515.

At transition 528, the swarm user client 515 may accept the client discount record 340. For example, Mark's swarm user client 515 may accept client discount record 340 and store the client discount record 340 within the secure element module 322 of the wireless device 105. In one embodiment, a barcode image 345 may be transmitted within the client discount record 340 to the swarm user client 515. In another embodiment, the barcode image 345 may be dynamically generated at the swarm user client 515 to reduce the amount of network traffic across the network 130. The acceptance time 347 may be stored by the swarm user client 515 such that a time and date is available for analytics at the swarm server 510. For example, the analytics module 413 may utilize the acceptance time 347 and/or redemption time 348 to track marketing trends, demographics, revenue gain/loss, viral marketing patterns, etc.

At transition 529, the swarm user client 515 may notify the swarm server 510 of the acceptance of the client discount record 340. In one embodiment, the swarm user client 515 may simply send back an acknowledgement via the network 130 indicating the client discount record 340 was received and/or accepted.

At transition 530, the swarm user client 515 may redeem the discount 343 contained within the client discount record 340. One of skill in the art will appreciate that a time delay may occur between the transition 529 and the transition 530. For example, Mark may accept a discount 343 for “20% Off Furniture Store Sofas After 6:00 p.m.” knowing that he must wait until 6:00 p.m. to redeem the discount. In another embodiment, the discount 343 may not be expressly limited by time; the user may simply want to wait until later to redeem the discount 343.

One of skill in the art will appreciate that there exists a number of ways to transmit the discount 343 from the swarm user client 515 to the merchant 505 (and ultimately to the swarm server 510). In one embodiment, the user may enter a command into the swarm user client 515 to display the discount 343 for the merchant 505. For example, the user may invoke a command into the user interface module 314 of the swarm user client 305 to have the wireless device 105 display the barcode image 345. The merchant 505 may then physically hold the wireless device 105 and scan the display of the wireless device 105 at the point-of-sale terminal 120 using the barcode reader 122.

In another embodiment, the swarm user client 515 may communicate with the point-of-sale terminal 120 via the NFC terminal 124. In yet another embodiment, the user of the wireless device 105 may verbally read a code to the merchant 505 who then enters the code into the point-of-sale terminal 120. In still another embodiment, the merchant 505 may read the code from the display of the wireless device 105 and may key the code into the point-of-sale terminal 120. In yet another embodiment, the merchant 505 may utilize a web-based interface at the swarm server 510 to enter a code into the swarm server 510 after the code has been displayed by the swarm user client 515.

Upon transmission, the discount 343 may be encoded, encrypted, or protected using any number of commonly known cryptography (“crypto”) techniques or cryptosystems. Examples of cryptosystems include RSA encryption, Schnorr signature, PGP encryption, El-Gamal encryption, etc. One of skill in the art will appreciate the security concerns and address them accordingly upon implementation of some embodiments.

At transition 533, the merchant 505 may request verification of the discount 343. In one embodiment, if the discount 343 is presented in the form of a barcode at the barcode reader 122, then the point-of-sale terminal 120 may send a request to the swarm server 510 to verify the data presented in the barcode. In another embodiment, if a code is presented to the merchant 505, then the merchant 505 may contact the swarm server 510 to verify the code. For example, if the code is read by the user to the merchant 505, then the merchant 505 may key in the code to the point-of-sale terminal 120 such that the point-of-sale terminal 120 may contact the swarm server 110. In another example, the merchant 505 may receive the code from the user and manually key the code into a web-based interface presented by the swarm server 110. In yet another example, the code may be telephonically communicated to the swarm server 110 to verify the discount (e.g., using touch-tones, voice commands, modem, etc.).

At transition 535, the swarm server 110 may verify the discount 343. As previously described with the transitions 530, 533, the merchant 505 may receive and communicate the discount 343 to the swarm server 510. In one embodiment, the swarm server 510 may verify a short code given by the user to the merchant 505. For example, the swarm user client 515 may generate a short code of “133t” which is verbally read to the merchant 505 who has already keyed in the short code at the transition 533; the swarm server 510 may then verify the validity of the short code as presented to the merchant 505 via the swarm user client 515.

At transition 537, an acknowledgement may be sent to the merchant 505 if the verification at the transition 535 was successful. For example, the swarm server 510 may send an acknowledgement to the point-of-sale terminal 120 indicating that the discount 343 was verified. In another example, the swarm server 510 may notify the merchant 505 via a web-based interface that the discount 343 was verified.

At transition 539, the swarm server 510 may send a notification of the redemption of the discount 343. The notification of the redemption may include a current date and time. In one embodiment, the swarm user client 515 may utilize the redemption time 348 to update the client discount records 340. As one of skill in the art will appreciate, the analytics module 413 may be utilized to gather, process, and present data related to the redemption of the discount 343 such that the marketing campaign may be accurately understood by those managing the marketing campaign.

At transition 541, the swarm user client 515 may process the redeemed discount 343. In one embodiment, the swarm user client 515 may invoke the discount module 313 and update the client discount record 340. Further, the redemption time 348 may be updated to the current date and time to indicate that the discount 343 was redeemed. One of skill in the art will appreciate that recording the time of redemption may provide information useful in creating new marketing campaigns as well as tailoring existing marketing campaigns.

At transition 543, the swarm server 510 may analyze the marketing campaign. In one embodiment, the swarm server 510 may utilize the analytics module 413 to process data including but not limited to: the marketing campaigns, the discounts, the participating swarm user clients, the non-participating swarm user clients, the participating merchants, the non-participating merchants, etc. In one embodiment, the processed data is presented via a web-based interface via the swarm server 510 such that the merchant 505 may control marketing campaigns and discounts. Further, the swarm server 510 may present any number of charts, graphs, figures, etc. such that the merchant 505 may visually understand the success/failure of the marketing campaign.

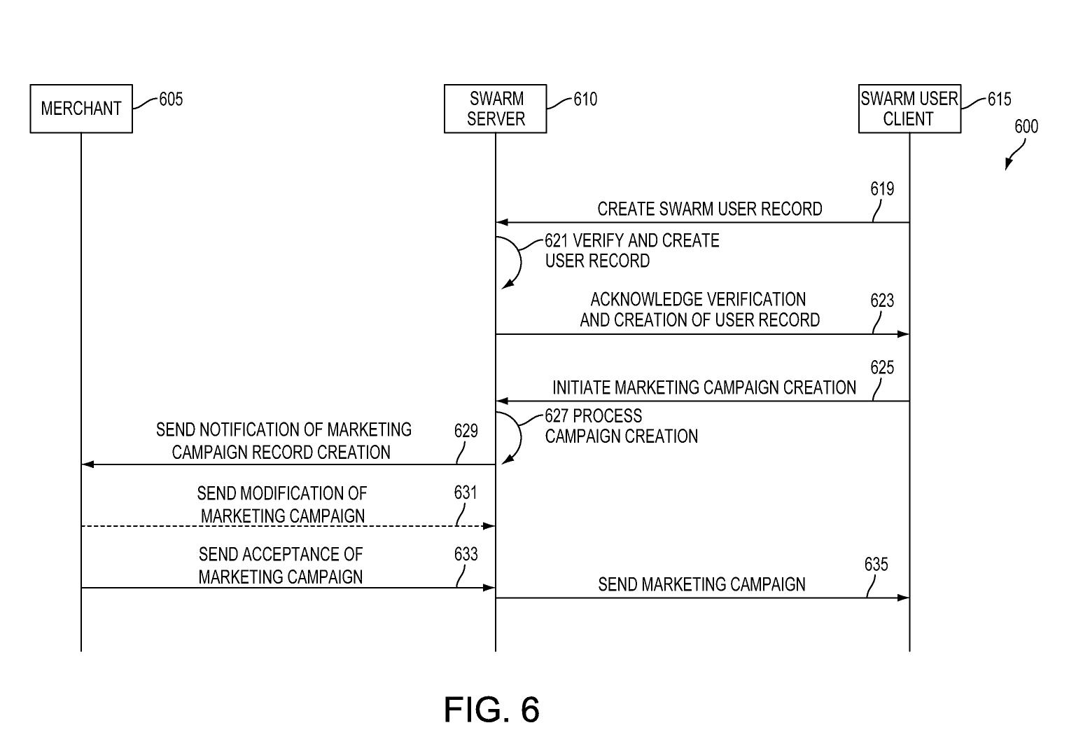

Turning to FIG. 6, a process 600 for creating a new swarm user client account is generally depicted. As shown, a merchant 605, a swarm server 610 and a swarm user client 615 may interact with one another. The merchant 605 may be a human manager of a store (e.g., the Caffeine Cart described above). In one embodiment, the swarm server 610 may be the swarm server 110 depicted in FIG. 1 above. In another embodiment, the swarm server 610 may be the swarm server 405 depicted in FIG. 4A above. In one embodiment, the swarm user client 615 may be swarm user client 305 depicted in FIG. 3A above. In still another embodiment, the swarm server 610 may be the swarm server 510 from FIG. 5 above. In one embodiment, the swarm user client 615 may be the swarm user client 305 from FIG. 3A. In another embodiment, the swarm user client 615 may be the swarm user client 515 from FIG. 5 above.

Prior to process 600 beginning, the swarm user client 615 may be downloaded and installed to a wireless device. One of skill in the art will appreciate that a number of methods exist for transmitting and installing applications on wireless devices. In one embodiment, the swarm server 610 may transmit the swarm user client 615 to the wireless device using a WAP push request. In another embodiment, wireless device users may be able to acquire applications via application stores (commonly referred to as “app stores”). Providers of application stores are Apple, Microsoft, Electronic Arts (“EA”), Valve, Stardock, Handango, Verizon, Sprint, AT&T, Alltel, Nokia, Samsung, LG, etc. The applications may be free or purchased. The application store may wirelessly transmit the application to the wireless device for installation.

Alternatively, the application may be transmitted via a cable connected to another computing device (e.g., a personal computer, a laptop, a kiosk, etc.). In yet another embodiment, applications may be transmitted “virally” from one wireless device to another wireless device (sometimes referred to as “superdistribution”). One of skill in the art may include any number of digital rights management schemes to protect the swarm user client 615 from unauthorized copying or use. At the transition 619, the swarm user client 615 may be utilized to create a user record 415 at the swarm server 610. In one embodiment, the swarm user client 615 may present a screen to the user of the wireless device 105 such that the user may select a personalized login name and secure password. In another embodiment, the swarm user client 615 may utilize the credentials of the wireless device 105 to create an account. For example, any of the following may be used to create a user account: the electronic serial number (“ESN”), mobile identification number (“MIN”), international mobile equipment identity (“IMEI”), subscriber identity, etc.

In one embodiment, the account creation is performed in conjunction with the user module 407. Further, a user record 415 may be created in response to account creation, and the user record may contain demographic information 418 and friend information 419. Further, the swarm server 610 may gather additional information about the user of the wireless device 105 to complete the user record 415. For example, the swarm server 610 may prompt the user for demographic information 418 such as age, gender, height, income, education, employer, occupation, hobbies, romantic interests, etc. One of skill in the art will appreciate that with the extensive network of databases that currently exist in the marketplace, the demographic information 418 may be obtained from a third party server. For example, Facebook and other social networking sites track many aspects of users' demographic information 418. If access to data in a third party server requires permission from the user, then the swarm server 610 may present a screen asking for such permission.

The swarm server 610 may request friend information 419 from the user to complete the user record 415. As previously stated, third-party servers store information related to friendships in the real-world (e.g., Facebook, Google® Buzz, MySpace, etc.). In one embodiment, the swarm server 610 may gather these relationships and store the relationships in the friend information 419 within the user record 415. Again, if permission is required from the user, the swarm server 610 may present a screen to gather such permission from the user.

At transition 621, the swarm server 610 may verify and create the user record 415. In one embodiment, the swarm server 610 may verify that the personalized login name is unique and the secure password meets security policies (e.g., longer than 8 characters and contains at least one numeric character). In one embodiment, the swarm server 610 may need to synchronize additional data with third-party servers.

At the transition 623, the swarm server 610 may acknowledge the verification and creation of the user record 415 to the swarm user client 615. In one embodiment, the swarm server 110 may send a message to the swarm user client 615 which appears on the screen (e.g., “Account Creation Successful!”). The swarm user client 615 may perform any necessary initialization and preparation in response to the acknowledgement.

At the transition 625, the swarm user client may initiate a marketing campaign creation with the swarm server 610. In one embodiment, the swarm user client 615 may create a marketing campaign using the campaign module 307 within the swarm user client 615. Further, the swarm user client 615 may create a new client campaign record 325 indicating the location 329 of the merchant 605 and the duration 331 of the proposed campaign. In one embodiment, the swarm user client 305 may communicate the proposed client campaign record 325 to the swarm server 610.

At the transition 627, the swarm server 610 processes the marketing campaign creation. In one embodiment, the swarm server 610 may utilize the campaign module 411 to verify that the marketing campaign meets criteria established by the administrator of the swarm server. If a proposed client campaign record 325 has been sent to the swarm server 610, then the swarm server 610 may utilize the campaign module 411 to create a server campaign record 425. In one embodiment, the swarm server 610 may have parameters associated with the server campaign records 425 to prevent duplicative marketing campaigns. One of skill in the art will appreciate that the server campaign record 425 and the client campaign record 325 are but one exemplary way to represent the marketing campaign electronically. Further, one of skill in the art may arrive at a different, yet functionally equivalent architecture without departing from the solutions proposed herein.

At the transitions 629, the swarm server 610 notifies the merchant 605 of the campaign creation. In one embodiment, the merchant 505 may receive a notification via a web-based interface indicating that the swarm user client 615 initiated a marketing campaign by creating a client campaign record 325 and transmitting the client campaign record 325 to the swarm server 610. For example, assume the merchant 605 operates a movie theater, and the merchant 605 receives a marketing campaign that indicates: (1) the first through twenty-fifth customers of the day will receive a discount of “buy one movie ticket, receive a free large bucket of popcorn,” and (2) the twenty-sixth through one-hundredth customers of the day will receive “buy one movie ticket, receive a free small cola.” The merchant may view the proposed marketing campaign and determine if the marketing campaign meets the merchant's 605 business criteria, goals, and/or expectations. For example, the merchant 605 may not be pleased about giving away free popcorn because she knows that popcorn supplies are lower during the winter because people like warm food (and corn is not in season). Having the marketing campaign presented to the merchant 605 allows for the merchant 605 to ensure that her business goals align with the marketing campaign proposed by the swarm user client 615. In one embodiment, the merchant 605 may interact with the inventory management server 119 to determine current inventory levels. For example, the popcorn supplies may be tracked by the inventory management server 119 in the example above.

One of skill in the art will appreciate that the merchant 605 may not know the identity of the user who initiated the marketing campaign. As previously stated, one benefit of crowdsourcing is that anonymity enhances creativity because the damage to one's ego is minimized when a bad idea is conceived and proposed to the public. Therefore, in one embodiment, the merchant 605 may only view a pseudonym of the user of the swarm user client 615 instead of the user's name. In another embodiment, the merchant 605 may only see a swarm user client 615 identifier (e.g. “User No. 1-22-333-4444”).

At the transition 631, the merchant 605 may modify the marketing campaign. Turning back to the example of the merchant 605 being a movie theater operator, the merchant 605 may change the first aspect of the marketing campaign to be “buy one movie ticket, receive a free large cola” instead of “buy one movie ticket, receive a free large bucket of popcorn.” Again, the merchant 605 may consider her business and financial goals when making such modifications to marketing campaigns proposed by the swarm user client 615. In one embodiment, the modification may be communicated to the swarm server 610 via the same web-based interface that presented the marketing campaign to the merchant 605 at the transition 626. One of skill in the art will appreciate that the web-based interface may include any number of menus, graphics, widgets, charts, graphs, demographic information, sales figures, maps, map overlays, etc. to enable the merchant 605 to finely tune the proposed marketing campaign to meet business and financial parameters.

At the transition 633, the merchant 605 may send acceptance of the marketing campaign. In one embodiment, the merchant 605 may utilize the web-based interface to accept the campaign using a standard click-through agreement containing a legally-binding contract between the merchant 605 and the public.

At the transition 635, the swarm server 610 may send the marketing campaign to the swarm user client 615. In one embodiment, the marketing campaign is received in the form of a client campaign record 325. One of skill in the art will appreciate that the relationship between the swarm server 610 and the swarm user client 615 may be one to many. Therefore, in one embodiment, the transmission of the marketing campaign may be accomplished through a multicast service. For instance, Qualcomm, Inc. based in San Diego, Calif. has developed MediaFLO® technology, which allows for Internet Protocol datacasting to many devices across the same physical spectrum thus saving bandwidth and power. MediaFLO® technology may be utilized to datacast to millions of swarm user clients 615 simultaneously such that thousands of marketing campaigns may be sent to millions of swarm user clients 615 with minimal impact on the network 130.

In another embodiment, the swarm server 610 may transmit the marketing campaign directly to each of the swarm user clients 615 via the Internet using standard IP. In yet another embodiment, the swarm server 610 may notify the swarm user clients 615 of the marketing campaign via SMS, MMS, etc. In still another embodiment, the marketing campaign may be transmitted using a Facebook® wall update. In yet another embodiment, the marketing campaign may be transmitted using a Twitter® tweet.

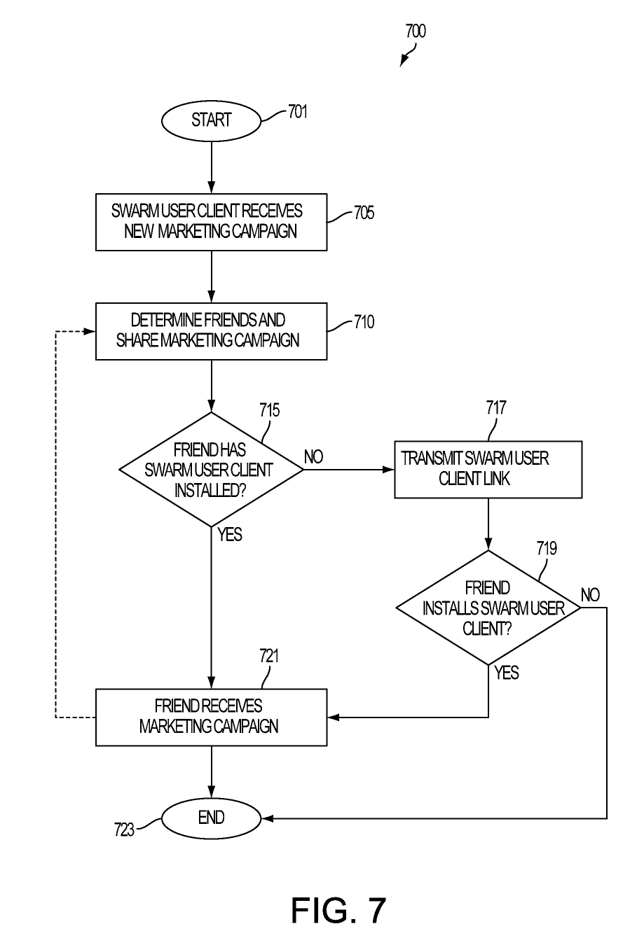

Turning to FIG. 7, a process 700 for adding friends to a marketing campaign is depicted. The process 700 begins at the START block 701. The process 700 may be utilized with any of the embodiments of the swarm server and the swarm user client described herein even though specific reference shall be made to the swarm user client 305. The process 700 proceeds to the block 705 where the swarm user client 305 receives a new marketing campaign. As previously discussed with respect to FIG. 6, the marketing campaign may be transmitted to the swarm user client 305 in a number of various manners.

The process 700 proceeds to the block 710 where the friends associated with the user of the swarm user client 305 are determined. As previously stated, the user may manually add friends via the swarm user client 305 in one embodiment. In another embodiment, relationships to real-world friends may be stored in third-party servers (such as Facebook). These relationships may be analyzed by the swarm user client 315 to ascertain potential friends who may be interested in joining the marketing campaign and obtaining a discount. In one embodiment, the friends potentially interested in the campaign may visually appear on the display of the wireless device 105 such that the user may touch icons to invoke the process 700 of sharing a marketing campaign. In one embodiment, the friend information 419 may be utilized to determine potential friends with whom to share the marketing campaign.

For example, Mindy is a Facebook® user and has a plurality of friends: Doug and Mark. Mindy has received a marketing campaign for Vintage Store, the local vintage clothing store. The marketing campaign may be defined as follows: (1) the first through twentieth customers receive “free vintage boots with purchase of any suit,” (2) the twenty-first through fiftieth customers receive “free scarf with purchase of any garment,” and (3) the fifty-first through one hundredth customers receive “5% off any purchase over $100.” Mindy may be able to view the profiles and pictures of her friends via the swarm user client's 305 user interface. The user interface module 314 may be invoked. The swarm user client 305 may suggest Doug is interested in the marketing campaign because he has “fashion” listed as one of his interests on his Facebook® profile. A visual indicator such a pair of boots or a star may be displayed next to Doug's profile to visually communicate to Mindy his potential interest in the marketing campaign.

The swarm user client 305 may indicate whether or not a user has the swarm user client 305 installed at their wireless device 105. Turning back to our example with Mindy above, Doug's profile may have an indicator next to his profile indicating Doug has the swarm user client 305 installed. In contrast, Mark would not have an indicator because he has not installed the swarm user client 305 yet.

The process 700 proceeds to decision block 715 once the marketing campaign has been shared with a friend. A determination whether the recipient has the swarm user client 305 installed or not is made. If the user does have the swarm user client 305 installed, the process 700 proceed along the YES branch to the block 721 where the friend receives the marketing campaign via the already-installed swarm user client 305. For example, if Mindy shares with Doug, then Mindy's swarm user client 305 would communicate with Doug's swarm user client 305 to share the marketing campaign. One of skill in the art will appreciate that the communication could happen via any one or more of the many manners described above. Further, the swarm server 110 may be involved as part of the process 700 as necessary.

Going back to the decision block 715, if a determination is made that the receiving friend does not already have the swarm user client 305, the process 700 proceeds along the NO branch to block 717 where the swarm user client 305 transmits a link to the receiving friend. For example, Mindy may share the marketing campaign with Mark who does not have the swarm user client 305 installed at his wireless device 105. Thus, Mindy's swarm user client 305 may create a formatted SMS message containing the following welcome message and hyperlink “Mindy wants you to join her to save 5% off any $100 purchase at Vintage Store. JOIN NOW!” Mark could click on a “JOIN NOW!” hyperlink and receive the swarm user client 305 via a WAP push.

The process 700 proceeds to the decision block 719 where a determination is made whether the receiving friend installs the swarm user client 305. If the receiving friend does not install the swarm user client 305, the process 700 proceeds along the NO branch to the END block 723 where process 700 terminates. Going back to the decision block 719, if the receiving friend does follow the hyperlink and installs the swarm user client 305, the process 700 proceeds along the YES branch to the block 721 where the marketing campaign is communicated to the newly-installed swarm user client 305. The process 700 proceeds to the END block 723 and terminates.

One of skill in the art will certainly notice the dotted line between the block 721 and the block 710 which indicates that the receiving friend may share the marketing campaign which they just received. Turning back to our example, Mark or Doug may decide to share the marketing campaign with a plurality of their friends. As will be understood, many users may virally share the marketing campaign and install the swarm user client 305. Aside from honoring the discount, the merchant has little to do with the viral nature of the marketing campaign because the users themselves will propagate the marketing campaign among their friends, many of which are connected electronically through social networking sites. Further, the users are rewarded for their efforts because they receive the discounts and are able to conveniently and securely store them within the swarm user client 305, in one embodiment.

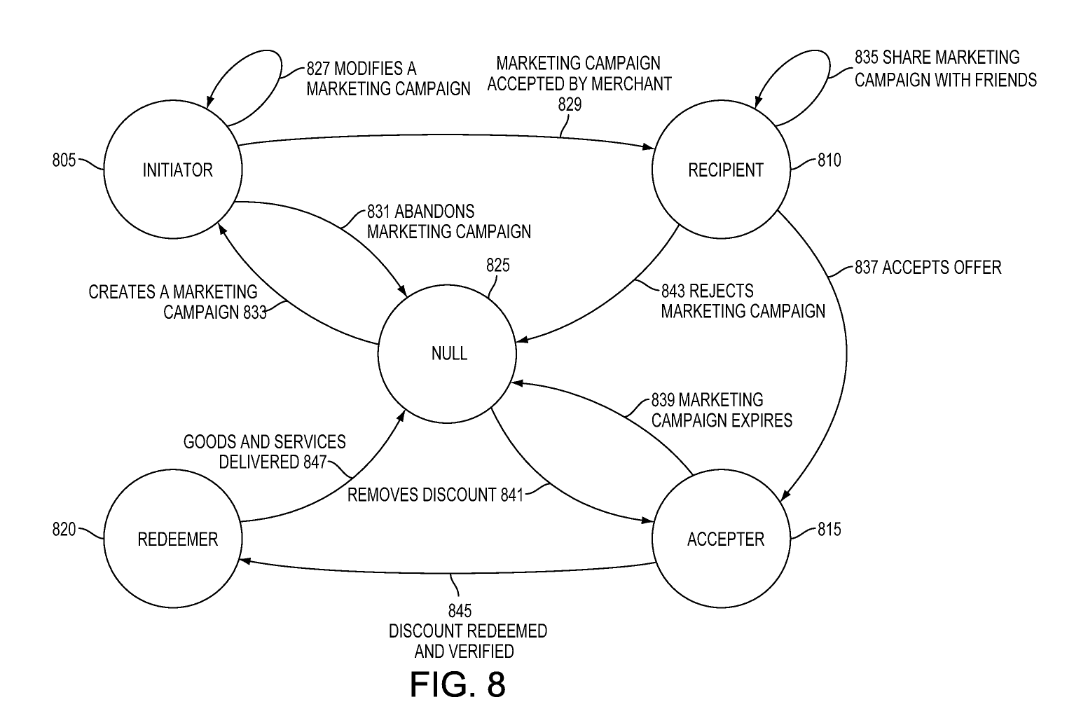

Turning to FIG. 8, a state diagram for the various user states is depicted. In one embodiment, the users of the marketing campaign system 100 may be identified by the swarm server 110 in a number of manners to track acceptance rates of marketing campaigns, viral effect of a marketing campaign, number of concurrent users, number of participating users, efficacy of a marketing campaign, the efficacy of a discount, etc. The states depicted in FIG. 8 provide some embodiments to track the states of users participating in a marketing campaign.

An initiator state 805 may be defined as a state where the user has initiated a marketing campaign. For example, the user may suggest a marketing campaign to a local dining establishment called Pizza Diner for “5% of all entrees to the first two hundred customers.” At transition 827, the user may modify the marketing campaign and still be in the initiator state 805. For instance, the user decides to change the marketing campaign from 5% off all entrees to 10% off all entrees. Note that the modification at the transition 827 may occur due to a merchant as was depicted previously in FIG. 6.

If the user abandons the marketing campaign, the transition 831 moves the user to a NULL state 825. Note that the merchant may abandon or terminate the marketing campaign and transition the user to the NULL state via the transition 831 as well. In the NULL state 825, the user may be considered as not participating in the marketing campaign. Likewise, if a user in the NULL state 825 creates a marketing campaign, the user moves along the transition 833 to the initiator state 805.

If the marketing campaign is accepted by a merchant, the transition 829 takes the user to a recipient state 810. The recipient state 810 may be defined as the state where user has received an offer to participate in a marketing campaign. As previously described with respect to FIG. 7, friends may send offers to other friends to join a marketing campaign and potentially receive a discount. Upon receiving the offer to join the “swarm,” the user may be said to be in the recipient state 810.

If the user rejects the offer, the transition 843 takes the user to the NULL state. Going back to the recipient state 810, if the user accepts the offer from a friend, for example, then the transition 837 moves the user to an accepter state 815. The accepter state 815 may be defined as a state where the user has accepted the marketing campaign and stored the discount within the swarm user client 305. In one embodiment, the discount 343 may be managed by the discount module 313 within the swarm user client 305 and securely stored in the secure element module 322.

As previously stated, marketing campaigns may have durations or time limits. If the duration of the marketing campaign is exceeded i.e. the discount is no longer valid, then the transition 839 moves the user to the NULL state 825. Similarly, if the user rejects the marketing campaign or any associated discounts, then the transition 841 moves the user to the NULL state 825 as well.

Going back to the accepter state 815, the transition 845 moves the user to a redeemer state 820 when the discount is redeemed and verified. For example, if the user walked into Vintage Store to redeem the discount 343 for free boots, then the user is said to be in the redeemer state 820. Note that any transition to the redeemer state 820 may be secured by requiring authentication and verification at the swarm server 110, in one embodiment. If the goods and/or services are delivered to the user based upon the discount, then the transition 847 moves the user to the NULL state 825.

One of skill in the art will appreciate the redeemer state 820 may be an opportune time to approach the user to present a subsequent discount. For example, assume that Doug initiates a successful campaign for a plurality of users to save on organic food from Food Co. Doug saved 15% on his purchase of various produce, and many others saves anywhere from 5% to 10% off produce, depending on their respective positions within the marketing campaign. Upon its conclusion, Doug will have been both an initiator and a redeemer. In one embodiment, Doug may be considered by the swarm server 110 to be a person who is valuable in initiating marketing campaigns. As such, the swarm server 110 may notify merchants that Doug has many friends and has successfully initiated a large, successful marketing campaign. In response to this information, the merchants may create a new marketing campaign with Doug as the initiator. In one embodiment, the merchant may give Doug a relatively large discount. For example, having successfully initiated a marketing campaign last time for 15%, Food Co. may give Doug a second discount of 30% off his entire purchase (not just produce) upon his next visit. Further, there may be enhanced discounts for Doug's friends who join the marketing campaign (e.g., they will receive 15 to 20% discounts on any items purchased instead of 5% to 10% for produce only). One of skill in the art will appreciate the business value of rewarding users who have previously transitioned through the initiator state 805.

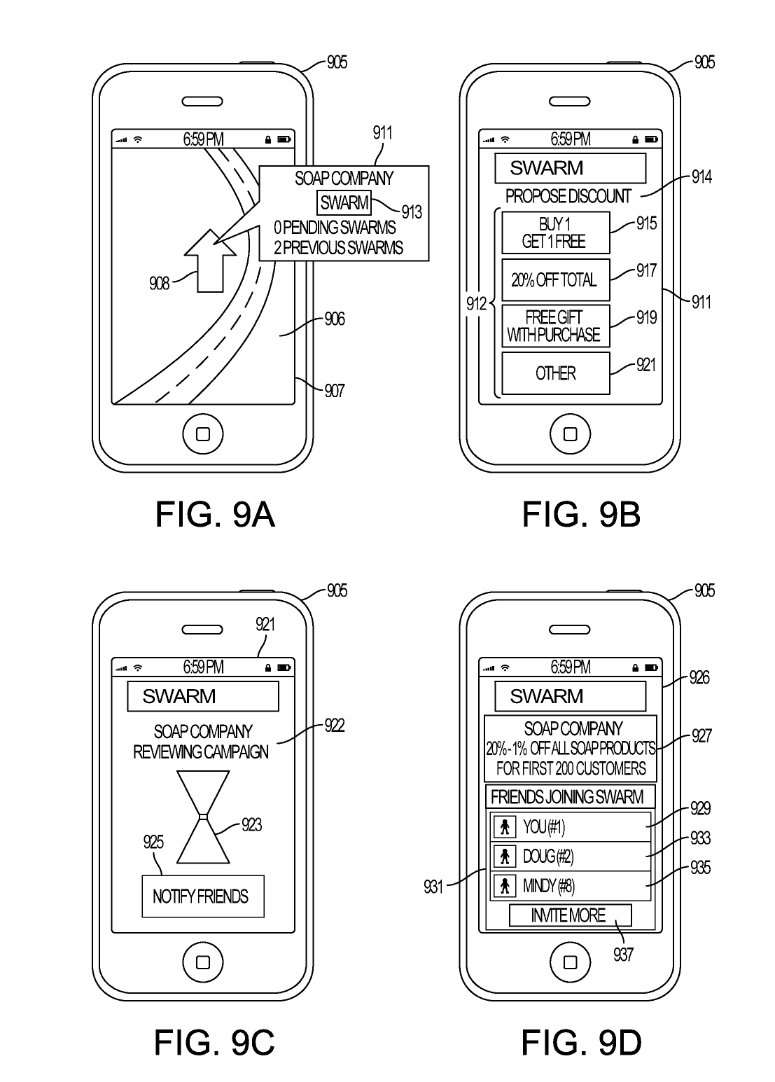

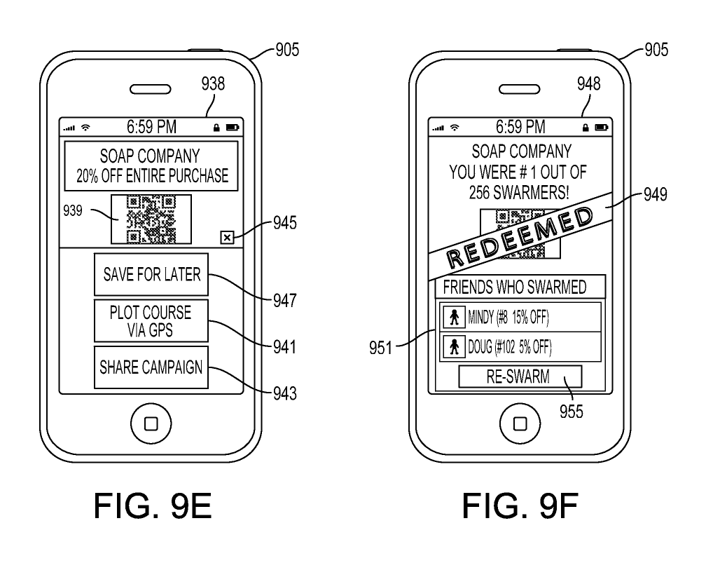

Turning to FIG. 9A through FIG. 9H a series of screenshots on a wireless device 905 are depicted. The depicted screenshots are provided to further enhance the understanding of the methods, systems, apparatuses, and computer-program products described herein.

FIG. 9A depicts a screenshot 907 of the swarm user client 305 browsing a city map 906. A merchant called the Soap Company is depicted with a building icon 908. The user may interact with the building icon 908 to invoke a popup dialog 911 which gives more information about the Soap Company. In one embodiment, the marketing campaigns may be referred to as “swarms.” Thus, the popup dialog 911 may indicate the number of pending swarms, previous swarms, expired swarms, etc. A swarm button 913 may be operable to being selected by the user to initiate a marketing campaign.

Turning to FIG. 9B, a screenshot 911 with a number of suggested discounts are presented for the marketing campaign. Instructions 914 may be shown to instruct the user how to operate the wireless device 905 to initiate a marketing campaign. One of skill in the art will appreciate that screen-size limitations, language limitations, business goals, and aesthetics may affect the composition of the instructions 914.

In one example, the user may be able to select from a series of discounts 912 to initiate a marketing campaign. Thus, the screenshot 911 may be iterative and shown multiple times to select the discount appropriate at each tier of the marketing campaign. For instance, the instructions 914 may read, “Choose a discount for first fifty customers.” The user may then choose from one of the discounts available on the screenshot 911, and then an updated version of the instructions 914 may appear, e.g., “Choose a discount for next one hundred customers.” And, the user may again select among various discounts. As one of skill in the art will appreciate, such an iterative series of screenshots allows the wireless device 905 to elegantly initiate a marketing campaign with limited screen resources.

The series of discounts 912 are depicted as the following buttons: a “Buy One, Get One Free” discount button 915, a “20% Off Total” button 917, and a “Free Gift with Purchase” button 919. The series of discounts 912 are self-explanatory and designed to accommodate the most common discounts requested by users. An other button 921 may be presented as well to allow the user to manually define a discount. Note, the user is not prohibited from making an unreasonable or even outlandish request. For example, the user may request that the first customer of the day should receive a “free pizza oven for buying one medium pizza” from Pizza Diner, a local pizza restaurant. As described above with respect to FIG. 6, the merchant may have the opportunity to review discounts within a marketing campaign to ascertain whether user-suggested discounts align with the merchant's business goals. Further, one of skill in the art appreciates that allowing user-generated content, discounts, promotions, etc. introduces risk for abuse and misuse of systems.

Turning to FIG. 9C, a screenshot 921 of the a pending marketing campaign is depicted. A message 922 from the swarm server 110 may be depicted indicating the status the request for a marketing campaign. As with the instructions 914 in FIG. 9B above, the message 922 may be dependent on similar considerations. An icon 923 may appear to visually indicate to the user that the swarm server 110 is awaiting an acknowledgement by the merchant. A button 925 may be presented to allow the user to invite friends to the swarm. In one embodiment, the button may be grayed out to prevent invitation prior to acceptance by the merchant. In one embodiment, the notify friends button 925 invokes the process 700 from FIG. 7 above.

In another embodiment, the user may share marketing campaigns prior to their acceptance as a means of inducing the merchant to accept the marketing campaign. For example, if the merchant knows that two hundred people have already shared the campaign and are willing to come into the merchant's place of business that day, then the merchant may be more willing to accept the marketing campaign. Going back to the “outlandish” request for a “free pizza oven for buying one medium pizza” discount, such a discount may make business sense if the user has obtained twenty-five thousand people to “swarm” Pizza Diner in one day. The merchant could potentially sell an extraordinary quantity of pizza that such sales would cover the cost of the pizza oven being given away as a promotional item.

Turning to FIG. 9D, a screenshot 926 is depicted. A dialog 927 indicates the currently accepted discount for the user. In the screenshot 926, the marketing campaign description is depicted as being “20% to 1% off all soap products for first two hundred customers.” The dialog 927 may rotate through the various discounts as offered by the marketing campaign. In many situations, such information about the other campaigns is purely informational because in some marketing campaigns, users will only be allowed to accept one discount. That being said, it is possible for a user to have accepted multiple discounts within the same marketing campaign in some embodiments.

A friend dialog 931 may be shown indicating which friends are currently in the marketing campaign i.e. swarm. A dialog 929 for the current user is shown. In one embodiment, a picture of the user may be shown along with their current position within the swarm. In the dialog 929, the owner of the wireless device 905 is the initiator of the campaign and thus is the first one in the swarm. A dialog 933 may be shown for another friend within the swarm. The dialog 933 shows Mark as being the second person in the swarm with whom the owner of the wireless device 905 shares an interpersonal relationship. Similarly, a dialog 935 is shown indicating that Mindy is the eighth person to join the swarm. A button 937 may be presented to invite even more people into the swarm. The button 937 may invoke the process 700 from FIG. 7 above, in one embodiment.

One of skill in the art will appreciate that the list of friends in the swarm as shown in the friend dialog 931 may grow and shrink over time. Some discounts may expire, thus pushing friends out of the swarm. Friends may invite friends, as depicted in FIG. 7, thus growing the list of friends virally. Friends may decline the discount after having accepted the discount and thus visually leave the friend dialog 931.

Turning to FIG. 9E, a screenshot 938 of a discount presentable at a merchant is depicted. A virtual coupon 939 may be displayed on the display of the wireless device 905. As depicted, a two-dimensional barcode 939 may be displayed and be operable to being scanned a point-of-sale terminal. A button 945 may be present to delete the discount from the swarm user client 305. A button 947 may be presented to save the discount to memory. In one embodiment, the discount is saved using the discount module 313 which may securely store the discount within the secure element module 322.

A button 941 may be presented to invoke global positioning system (“GPS”) assistance to navigate to the merchant. In one embodiment, the swarm user client 305 may sleep and invoke a mapping program such as Google® Maps which may be readily found on many Android® wireless devices. In another embodiment, the swarm user client 305 may be configured to provide navigation support without assistance from third-party applications.

A share campaign button 943 may be presented. As described in FIG. 7, the user may invoke the process 700 to share the marketing campaign among friends.

Turning to FIG. 9F, a screenshot 948 of a redeemed discount is depicted. A redeemed virtual coupon 949 may be depicted. In this example, the words “redeemed” appear across the face of the coupon to prevent subsequent scanning by points-of-sale terminals 120. Further, a redeemed virtual coupon 949 may contain post-mortem information such as where the user was in the marketing campaign. In this case, a message indicating the user of the wireless device 905 was first may be “You were #1 out of 256 swarmers.” A friends statistics dialog 951 may be present indicating where in the swarm the user's friends were. In this example, Mindy was number eight in the swarm and received 15% off her purchase. Whereas, Doug was number one hundred two and received only 5% off his purchase. Note that Mark was present in the friend dialog 931 but is not present in the friends statistics dialog 951 to illustrate the dynamic nature of a swarm. For instance, Mark may have left the swarm voluntarily, deciding that he could not make it to the Soap Company to redeem in the discount before its expiration because he was at Pizza Diner.

Finally, a button 955 may be present to allow the user of the wireless device 905 to initiate a new marketing campaign i.e. “re-swarm.” One of skill in the art will appreciate that placing the button 955 near the statistics pages is an opportune time to gather more interest in creating a new swarm because the user may enjoying the satisfaction of having saved her friends a great deal of money and thus willing to try it again at a new merchant.

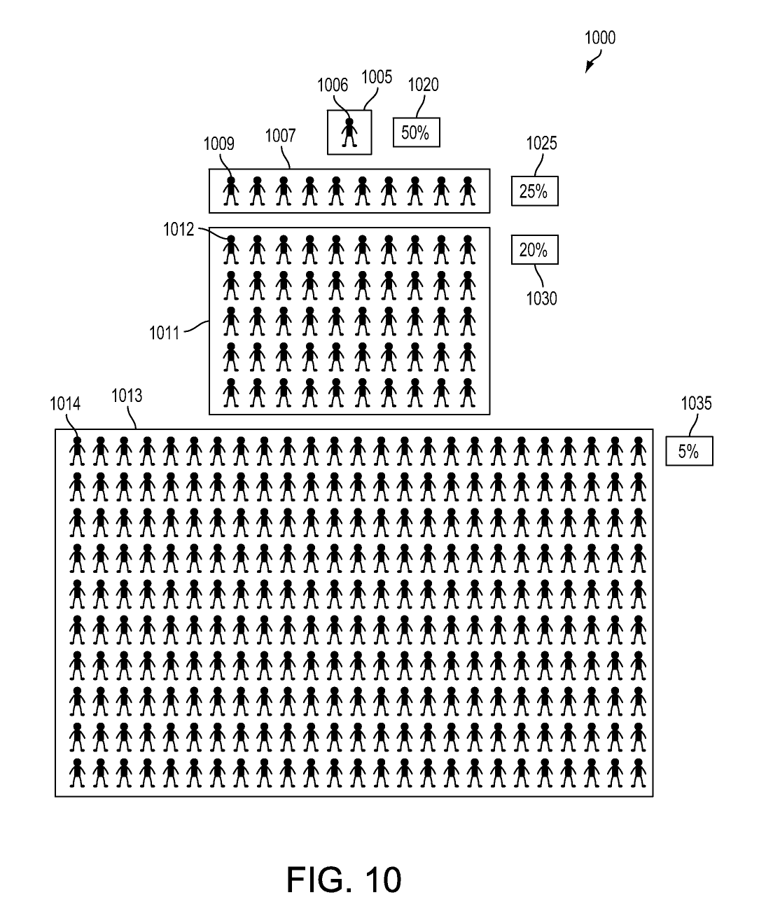

Turning to FIG. 10, a visual depiction of a marketing campaign 1000 (or swarm) is shown. As one skilled in the art will appreciate, a marketing campaign 1000 may be tiered. A first tier 1005 may be present for an initiator 1006 of the marketing campaign 1000. The initiator may receive a discount 1020 of 50% off his purchase. A second tier 1007 may have a plurality of participants 1009 who receive a discount 1025 of 25% off. A third tier 1011 with a plurality of participants 1012 may receive a discount 1030 of 20% off. A fourth tier 1010 may have a plurality of participants 1014 who receive a discount 1035 of 5% off.

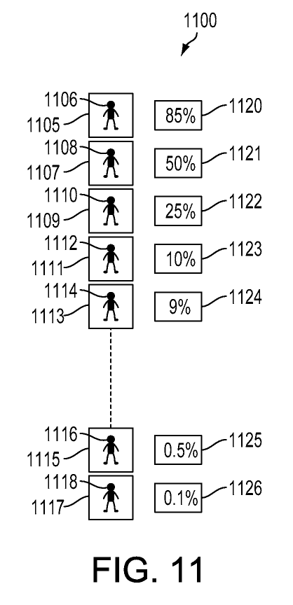

As one of skill in the art will appreciate, a marketing campaign need not be tiered in a triangular shape (e.g., with more users at the bottom than at the top). Turning to FIG. 11, yet another marketing campaign 1100 is depicted. The marketing campaign 1100 may be more suitable for an automobile retailer who wants to give a linear but rapidly decreasing discount. Note that for high-priced items (such as cars, furniture, boats, medical procedures, legal fees, etc.), a 0.1% discount may still be substantial enough to entice a potential customer. An initiator 1106 may be at a first tier and receive a discount 1120 of 85% off. As one of skill in the art will appreciate, the discount progressively becomes less as a final tier 1117 is reached where the discount 1126 is only for 0.1%. Thus, a recipient 1118 may only receive the discount 1126 of 0.1%. However, the marketing campaign 1110 may be an interesting proposition for both merchants and customers of highly priced goods/services.

One of skill in the art will appreciate that the some of the foregoing embodiments have described the merchant as operating a physical or “brick-and-mortar” place of business, but the proposed solution may be implemented to be used for online merchants as well. For example, Amazon.com is a large merchant of online goods and services. In one embodiment, an online merchant may utilize the marketing campaign proposed in some of the embodiments above. Further, online merchants may operate a swarm server (or a functional equivalent) within their own servers, which are already required for their online storefront. In one embodiment, these online merchants may specially brand the swarm user client and/or the swarm server in order to promote their online goods and services.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk, High Definition DVD (“HD-DVD”) and Blu-ray disc where disks usually reproduce data magnetically, while discs reproduce data optically with lasers. Combinations of the above should also be included within the scope of computer-readable media.

Although selected embodiments have been illustrated and described in detail, it will be understood that various substitutions and alterations may be made therein without departing from the spirit and scope of the present invention, as defined by the following claims.

What is claimed is:

1. A method for mobile commerce on a wireless device, the method comprising:
receiving a discount, the discount being redeemable at a merchant and being associated with a marketing campaign, the marketing campaign defining a plurality of discounts, the plurality of discounts comprising:
a first discount redeemable by a first wireless device initiating the marketing campaign; and
a second discount redeemable by at least one second wireless device, wherein the first discount is not the same as the second discount.

2. The method of claim 1, further comprising:
accepting the discount at the wireless device; and
storing the discount in memory at the wireless device.

3. The method of claim 2, further comprising:
redeeming the discount at the merchant.

4. The method of claim 2, further comprising:
encrypting the discount in the memory.

5. The method of claim 1, further comprising:
initiating the marketing campaign at the wireless device, wherein the discount received at the wireless device is the first discount and the wireless device is the first wireless device.

6. The method of claim 1, further comprising:
determining the discount based on a condition associated with the marketing campaign; and
transmitting the discount.

7. The method of claim 6, wherein the condition is the number of wireless devices having already accepted the discount.

8. The method of claim 6, wherein the transmitting is to a third wireless device, the third wireless device receiving a third discount based on the condition associated with the marketing campaign, wherein the third discount is not the same as the first discount or the second discount.

9. The method of claim 1, further comprising:
gathering data related to the receiving of the discount, the accepting of the discount, the transmitting of the discount, the storing of the discount, the redemption of the discount, or combination thereof; and
determining analytics on the gathered data.

10. The method of claim 1, wherein the discount is redeemable via one-dimensional barcode, two-dimensional barcode, a code, or combination thereof

11. A wireless device for mobile commerce, the wireless device comprising:
means for receiving a discount, the discount being redeemable at a merchant and being associated with a marketing campaign, the marketing campaign defining a plurality of discounts, the plurality of discounts comprising:
a first discount redeemable by a first wireless device initiating the marketing campaign; and
a second discount redeemable by at least one second wireless device, wherein the first discount is not the same as the second discount.

12. The wireless device of claim 11, further comprising:
means for accepting the discount at the wireless device; and
means for storing the discount in memory at the wireless device.

13. The wireless device of claim 12, further comprising:
means for redeeming the discount at the merchant.

14. The wireless device of claim 12, further comprising:
means for encrypting the discount in the memory.

15. The wireless device of claim 11, further comprising:
means for initiating the marketing campaign at the wireless device, wherein the discount received at the wireless device is the first discount and the wireless device is the first wireless device.

16. The wireless device of claim 11, further comprising:
means for determining the discount based on a condition associated with the marketing campaign; and
means for transmitting the discount.

17. The wireless device of claim 16, wherein the condition is the number of wireless devices having already accepted the discount.

18. The wireless device of claim 16, wherein the transmitting is to a third wireless device, the third wireless device receiving a third discount based on the condition associated with the marketing campaign, wherein the third discount is not the same as the first discount or the second discount.

19. The wireless device of claim 11, further comprising:
means for gathering data related to the receiving of the discount, the accepting of the discount, the transmitting of the discount, the storing of the discount, the redemption of the discount, or combination thereof and means for determining analytics on the gathered data.

20. The wireless device of claim 11, wherein the discount is redeemable via one-dimensional barcode, two-dimensional barcode, a code, or combination thereof

21. A computer program product comprising a computer usable medium having a computer readable program code embodied therein, said computer readable program code adapted to be executed to implement a method for managing a marketing campaign, said method comprising:
receiving a discount, the discount being redeemable at a merchant and being associated with the marketing campaign, the marketing campaign defining a plurality of discounts, the plurality of discounts comprising:
a first discount redeemable by a first wireless device initiating the marketing campaign; and
a second discount redeemable by at least one second wireless device, wherein the first discount is not the same as the second discount.

22. The computer program product of claim 21, wherein the program code implementing the method further comprises:
accepting the discount at the wireless device; and
storing the discount in memory at the wireless device.

23. The computer program product of claim 22, wherein the program code implementing the method further comprises:
redeeming the discount at the merchant.

24. The computer program product of claim 22, wherein the program code implementing the method further comprises:
encrypting the discount in the memory.

25. The computer program product of claim 21, wherein the program code implementing the method further comprises:
initiating the marketing campaign at the wireless device, wherein the discount received at the wireless device is the first discount and the wireless device is the first wireless device.

26. The computer program product of claim 21, wherein the program code implementing the method further comprises:
determining the discount based on a condition associated with the marketing campaign; and
transmitting the discount.

27. The computer program product of claim 26, wherein the condition is the number of wireless devices having already accepted the discount.

28. The computer program product of claim 26, wherein the transmitting is to a third wireless device, the third wireless device receiving a third discount based on the condition associated with the marketing campaign, wherein the third discount is not the same as the first discount or the second discount.

29. The computer program product of claim 21, wherein the program code implementing the method further comprises:
gathering data related to the receiving of the discount, the accepting of the discount, the transmitting of the discount, the storing of the discount, the redemption of the discount, or combination thereof and
determining analytics on the gathered data.

30. The computer program product of claim 21, wherein the discount is redeemable via one-dimensional barcode, two-dimensional barcode, a code, or combination thereof

31. A wireless device for mobile commerce, the wireless device comprising:
a memory operable to store a discount;
a transceiver operable to receive the discount; and
a processor operable to:
receive the discount via the transceiver, the discount being redeemable at a merchant and being associated with a marketing campaign, the marketing campaign defining a plurality of discounts, the plurality of discounts comprising:
a first discount redeemable by a first wireless device initiating the marketing campaign; and
a second discount redeemable by at least one second wireless device, wherein the first discount is not the same as the second discount.

32. The wireless device of claim 31, the processor being further operable to:
accept the discount at the wireless device; and
store the discount in memory at the wireless device.

33. The wireless device of claim 32, the processor being further operable to:
redeem the discount at the merchant.

34. The wireless device of claim 32, the processor being further operable to:
encrypt the discount in the memory.

35. The wireless device of claim 31, the processor being further operable to:
initiate the marketing campaign at the wireless device, wherein the discount received at the wireless device is the first discount and the wireless device is the first wireless device.

36. The wireless device of claim 31, the processor being further operable to:
determine the discount based on a condition associated with the marketing campaign; and
transmit the discount.

37. The wireless device of claim 36, wherein the condition is the number of wireless devices having already accepted the discount.

38. The wireless device of claim 36, wherein the transmitting is to a third wireless device, the third wireless device receiving a third discount based on the condition associated with the marketing campaign, wherein the third discount is not the same as the first discount or the second discount.

39. The wireless device of claim 31, the processor being further operable to:
gather data related to the receiving of the discount, the accepting of the discount, the transmitting of the discount, the storing of the discount, the redemption of the discount, or combination thereof; and
determine analytics on the gathered data.

40. The wireless device of claim 31, wherein the discount is redeemable via one-dimensional barcode, two-dimensional barcode, a code, or combination thereof
